(19) United States
(12) Patent Application Publication
(10) Pub. No.: US 2021/0166269 A1
(43) Pub. Date: Jun. 3, 2021

(54) AGGREGATED SYSTEM AND METHOD FOR ADVERTISEMENT CONTROL

(71) Applicant: SONY CORPORATION, TOKYO (JP)

(72) Inventors: JAISON JOSEPH, BANGALORE (IN); ANIL SASIDHARAN, BANGALORE (IN)

(21) Appl. No.: 16/701,757

(22) Filed: Dec. 3, 2019

(51) Int. Cl. G06Q 30/02

(52) U.S. Cl. CPC G06Q 30/0261; G06Q 30/0205; G06Q 30/0246; G06Q 30/0276; G06Q 30/0273; G06Q 30/0269; G06Q 30/0264

(57) ABSTRACT

A server that includes first circuitry is provided. The first circuitry receives first information from an electronic apparatus. The first information indicates a geographical region of interest to render advertisement content. The geographical region of interest includes a plurality of nodes to render the advertisement content. The first circuitry further receives second information from the electronic apparatus. The second information is about a user selection of a node from the plurality of nodes located in the region of interest. Further, the first circuitry transmits the advertisement content to the selected node. The advertisement content is rendered on the selected node.

### CROSS-REFERENCE TO RELATED APPLICATIONS/INCORPORATION BY REFERENCE

None.

### FIELD

Various embodiments of the disclosure relate to advertisement control. More specifically, various embodiments of the disclosure relate to aggregated system and method for advertisement control.

### BACKGROUND

Recent advancements in the field of digital marketing have led to development of various techniques and systems to provide advertisements to various audience. In certain situations, digital advertisements are broadcasted to the audience through different communication devices (such as televisions). In such situations, the audience for the advertisements may be targeted based on various factors (for example age, gender).

The limitations and disadvantages of conventional and traditional approaches will become apparent to one of skill in the art, through comparison of described systems with some aspects of the present disclosure, as set forth in the remainder of the present application and with reference to the drawings.

### SUMMARY

An aggregated system and method for advertisement control, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary environment for advertisement control based on location selection, in accordance with an embodiment of the disclosure.

FIG. 2 is a block diagram that illustrates an exemplary server for advertisement control based on location selection, in accordance with an embodiment of the disclosure.

FIG. 3 is a sequence diagram that illustrates a first implementation scenario of advertisement control based on location selection, in accordance with an embodiment of the disclosure.

FIG. 4 is a block diagram that illustrates an exemplary electronic apparatus for advertisement control based on location selection, in accordance with an embodiment of the disclosure.

FIGS. 5A-5C are diagrams that collectively illustrate exemplary user interfaces that may be presented on a display device of the electronic apparatus of FIG. 4, in accordance with an embodiment of the disclosure.

FIG. 6 is a block diagram that illustrates an exemplary node of a plurality of nodes located at a region of interest, for render of advertisement content, in accordance with an embodiment of the disclosure.

FIG. 7 is a sequence diagram that illustrates a second implementation scenario for generation of statistical information based on rendered advertisement control, in accordance with an embodiment of the disclosure.

FIG. 8 depicts a flowchart that illustrates an exemplary method for advertisement control based on location selection, in accordance with an embodiment of the disclosure.

### DETAILED DESCRIPTION

Various embodiments of the present disclosure may be found in a server for advertisement control based on location which may be selected by an electronic apparatus (for example associated with an advertiser). Exemplary aspects of the disclosure provide a server that may be configured to receive first information from an electronic apparatus. The first information may indicate a region of interest (associated with a geographical location) to render advertisement content. The geographical region of interest may include a plurality of nodes (e.g., televisions (TVs), sound systems, interactive screens/kiosks, and smart speakers) to render the advertisement content. The server may be further configured to receive second information from the electronic apparatus. The second information may include user selection of a node (or set of nodes) from the plurality of nodes. For example, the user selection may include a selection of a particular TV or kiosk at a particular shop in the geographical location associated with the region of interest. The server may be further configured to transmit the advertisement content to the selected node from the plurality of nodes. The transmitted advertisement content may be further rendered by the selected node (e.g., the selected TV/kiosk at the selected shop in the geographical region).

Thus, the server and the electronic apparatus may provide a flexibility to a user (such as the advertiser) to select individual nodes (e.g., TVs/kiosks) within the region of interest (i.e. a selected geographical location) to render the advertisement content. The flexibility to select individual nodes may be beneficial as the user may delineate specific nodes (such as TV/kiosk terminals within various shops or places) at which the particular advertisement content may be relevant to further yield audience interest and increase awareness and/or sales of an advertised products/services. For example, the advertisement content associated with kid's toys may be relevant to toy and gift shops. Thus, nodes (e.g., kiosks) of such toy and gift shops may be selected by the advertiser (through the electronic apparatus) such that the disclosed server may render the advertisement content related to the toys on the selected nodes, to further boost sales of the toys or different other products.

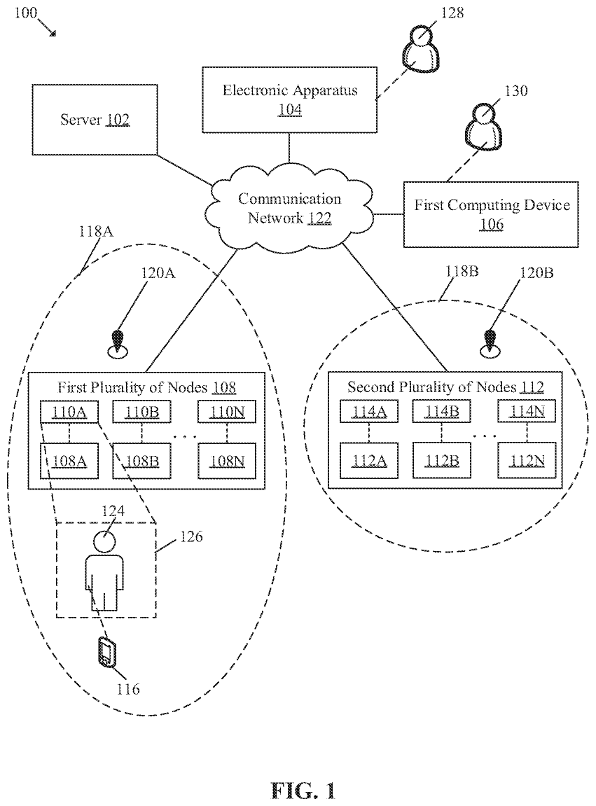

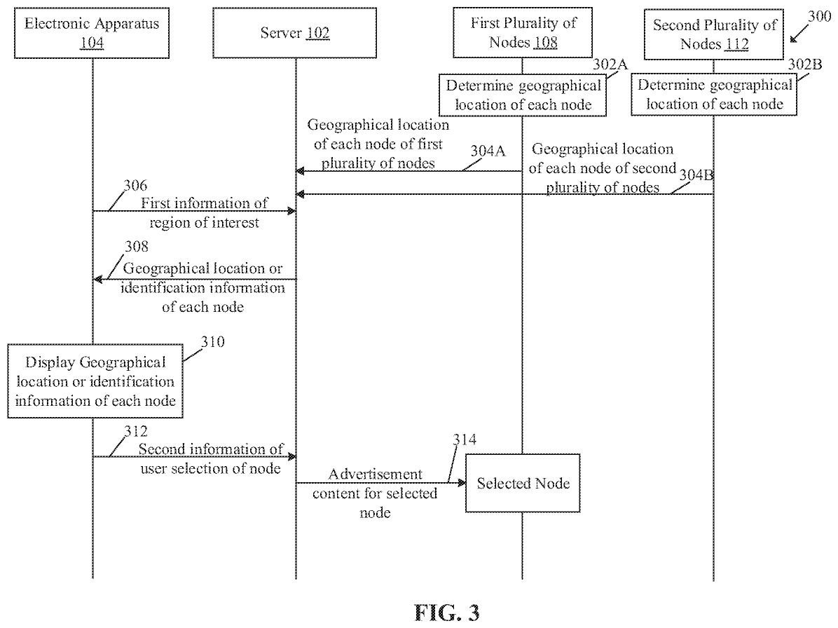

FIG. 1 is a block diagram that illustrates an exemplary environment for advertisement control based on location selection, in accordance with an embodiment of the disclosure. With reference to FIG. 1, there is shown a network environment 100 that may include a server 102, an electronic apparatus 104, a first computing device 106, a first plurality of nodes 108, and a second plurality of nodes 112, and a communication network 122. The electronic apparatus 104 may be associated with an advertiser 128. Further, the first computing device 106 may be associated with an advertisement consultant 130 (for example an advertisement agent). The first plurality of nodes 108 may include a first node 108A, a second node 108B, . . . and an Nth node 108N, while the second plurality of nodes 112 may include a first node 112A, a second node 112B, . . . and an Nth node 112N. Further, each of the first plurality of nodes 108 and each of the second plurality of nodes 112 may include and/or may be communicatively coupled to a respective image capturing device. For example, as shown in FIG. 1, the first node 108A may be associated with a first image capturing device 110A, the second node 1088 may be associated with a second image capturing device 110B, . . . and the Nth node 108N may be associated with an Nth image capturing device 110N. Similarly, the first node 112A of the second plurality of nodes 112 may be associated with a first image capturing device 114A, the second node 1128 may be associated with a second image capturing device 114B, . . . and the Nth node 112N may be associated with an Nth image capturing device 114N. In an embodiment, the combination of the server 102, the electronic apparatus 104, the first computing device 106, the first plurality of nodes 108, and the second plurality of nodes 112 may form an aggregated system for advertisement control, as described, for example, in FIGS. 3, 4, 5A-5C, 6, and 7.

In accordance with an embodiment, the first plurality of nodes 108 may lie in a first region 118A (i.e. geographical region), while the second plurality of nodes 112 may lie in a second region 1188 (i.e. geographical region). Each node in the first plurality of nodes 108 and the second plurality of nodes 112 may lie at a certain geographical location within the first region 118A and the second region 1188, respectively. For example, the first node 108A of the first plurality of nodes 108 may be located at or around a first geographical location 120A within the first region 118A. Further, the first node 112A of the second plurality of nodes 112 may be located at or around a second geographical location 1208 within the second region 1188. The first region 118A and the first geographical location 120A may be different from the second region 1188 and the second geographical location 1208, respectively.

There is further shown in FIG. 1, an audience member 124 present in a field-of-view (FOV) 126 of an image capturing device (e.g., the first image capturing device 110A) of a node (e.g., the first node 108A) from the first plurality of nodes 108. The audience member 124 may be a viewer or listener to whom the advertisement content may be rendered through the first plurality of nodes 108. In addition, in FIG. 1 there is shown a second computing device 116 of the audience member 124. The server 102, the electronic apparatus 104, first computing device 106, the first plurality of nodes 108, and the second plurality of nodes 112 (and additionally, the second computing device 116) may be communicatively coupled to one another, via the communication network 122.

The N number of nodes in each of the first plurality of nodes 108 and the second plurality of nodes 112 shown in FIG. 1 is presented merely as an example. Each of the first plurality of nodes 108 and the second plurality of nodes 112 may include only one node or more than N nodes, without a deviation from scope of the disclosure. The two regions (such as, the first region 118A and the second region 118B) shown in FIG. 1 is presented merely as an example. The network environment 100 may include only two regions or more than two regions, without a deviation from scope of the disclosure. The single number of advertiser (such as the advertiser 128), the advertisement consultant (such as the advertisement consultant 130), and audience member (such as the audience member 124), and respective devices (such as, the electronic apparatus 104, the first computing device 106, and the second computing device 116, respectively) shown in FIG. 1 is presented merely as an example. The network environment 100 may include more than one advertiser 128, the advertisement consultant 130, the audience member 124, and the respective devices such as the electronic apparatus 104, the first computing device 106, and the second computing device 116, without deviation from scope of the disclosure.

The server 102 may comprise suitable logic, circuitry, interfaces, and/or code that may be configured to control the distribution of the advertisement content to one or more nodes selected from a plurality of nodes in a geo-graphical region of interest. The server 102 may be configured to receive geographical location information of a plurality of nodes associated with one or more regions. For example, the server 102 may receive the geographical location information of each node in the first plurality of nodes 108 and the second plurality of nodes 112. The server 102 may be configured to receive first information from the electronic apparatus 104 of the advertiser 128. The electronic apparatus 104 and the advertiser 128 may be registered with the server 102. The first information may indicate the geographical region of interest (for example locality, city, town, state, or country) which may include the plurality of nodes (such as the first plurality of nodes 108) to render the advertisement content. The server 102 may be further configured to transmit the geographical location information associated with each of the plurality of nodes, located in the region of interest, to the electronic apparatus 104 for display of the geographical location information on the electronic apparatus 104. For example, the server 102 may transmit the geographical location information indicative of the first geographical location 120A (i.e. associated with the first node 108A of the first plurality of nodes 108) to the electronic apparatus 104, in case, the first information indicates the region of interest as the first region 118A. The server 102 may be further configured to receive second information from the electronic apparatus 104 based on the display of the geographical location information of each node on the electronic apparatus 104. The second information may indicate a user selection of a node (e.g., the first node 108A) from the plurality of nodes (e.g., the first plurality of nodes 108) located within the region of interest (e.g., the first region 118A) indicated in the first information. The server 102 may be further configured to transmit the advertisement content to the selected node (e.g., the first node 108A) to render the advertisement content on the selected node (i.e., the first node 108A). Examples of the server 102 may include, but are not limited to, an advertisement server, an artificial intelligence (Al)-based server, an application server, a media server, a cloud server, a mainframe server, a database server, a file server, a web server, or other types of servers. A person with ordinary skill in the art may understand that the scope of the disclosure should not be limited to user selection of only one node (e.g., the first node 108A). In certain situations, the user selection may correspond to selection of multiple nodes (e.g., the first node 108A and the second node 108B) without departure from the scope of the disclosure.

The electronic apparatus 104 may include suitable logic, circuitry, interfaces, and/or code that may be configured to generate the first information and the second information, and transmit the first information and the second information to the server 102. In accordance with an embodiment, the electronic apparatus 104 may be associated with the advertiser 128. The electronic apparatus 104 may be configured to generate the first information based on a first user-input received from the advertiser 128. The first user-input may include an indication of a region of interest (e.g., the first region 118A) to render the advertisement content. The electronic apparatus 104 may be configured to transmit the first information to the server 102 and receive the geographical location information (e.g., the first geographical location 120A) associated with each of the plurality of nodes (e.g., the first node 108A of the first plurality of nodes 108) in the indicated region of interest (i.e., the first region 118A) from the server 102. The electronic apparatus 104 may be further configured to display the geographical location information associated with each of the plurality of nodes (i.e., the first plurality of nodes 108). The electronic apparatus 104 may be further configured to receive a second user-input from the advertiser 128 and generate the second information based on the received second user-input. The second user-input may indicate the user selection of a node (e.g., the first node 108A) or multiple nodes (e.g., the first node 108A and the second node 108B) from the plurality of nodes (i.e., the first plurality of nodes 108) in the indicated region of interest (i.e., the first region 118A). The electronic apparatus 104 may be further configured to transmit the second information to the server 102 for render of the advertisement content on the selected node, for example, the first node 108A. Examples of the electronic apparatus 104 may include, but are not limited to, a handheld computer, a computing device, a cellular/mobile phone, a smart phone, a mainframe machine, a gaming device, a tablet computing device, a Personal Computer (PC), a consumer electronics (CE) device, and other computing devices.

The first computing device 106 may include suitable logic, circuitry, interfaces, and/or code that may be configured to create or assist in creation of the advertisement content for the advertiser 128. In accordance with an embodiment, the first computing device 106 may be associated or managed by the advertisement consultant 130 (for example an advertisement agent). The first computing device 106 may be configured to provide recommendations associated with the region of interest and node selection to the advertiser 128, based on user-input received from the advertisement consultant 130. The first computing device 106 associated with the advertisement consultant 130 may receive requests from the electronic apparatus 104 to create the advertisement content or assist in the creation of the advertisement content. Examples of the first computing device 106 may include, but are not limited to, a computing device, a mobile phone, a smart phone, a tablet computing device, a computer workstation, a gaming console, an automotive electronic device, or other consumer electronic device.

In an embodiment, each node of the first plurality of nodes 108 and the second plurality of nodes 112 may include suitable logic, circuitry, interfaces, and/or code that may be configured to render media content, (such as the advertisement content) that may be received from the server 102. In an embodiment, a node from the first plurality of nodes 108 or the second plurality of nodes 112 may render the advertisement content, in case the node is selected to render the advertisement content, based on the second information (provided by the electronic apparatus 104). The selected node (e.g., the first node 108A) may be further configured to control the image capturing device (i.e., the first image capturing device 110A) corresponding to the node to capture one or more images of an audience (e.g., the audience member 124) to whom the advertisement content may be rendered. In some embodiments, the first plurality of nodes 108 and/or the second plurality of nodes 112 may be associated with the advertiser 128. For examples, advertiser 128 and one or more nodes of the first plurality of nodes 108 and/or the second plurality of nodes 112 may belong to same organization. Examples of the first plurality of nodes 108 and/or the second plurality of nodes 112 may include, but are not limited to, a television, a digital billboard, a display screen, a kiosk device, an Internet-of-things (IOT) device, a mobile phone, a tablet computing device, a personal computer, a gaming console, a media player, a speaker device, a sound system, a home theatre system, a head-mounted device, an automotive electrical device, an electrical musical instrument, or other electrical device capable to render media content, such as the advertisement content.

In an embodiment, each of the image capturing devices (such as, the first image capturing device 110A, the second image capturing device 1108) may include suitable logic, circuitry, interfaces, and/or code that may be configured to capture one or more image frames. For example, the first image capturing device 110A may capture an image of the audience member 124 associated with the first node 108A based on a field of view (FOV) 126 of the first image capturing device 110A. Each image capturing device (e.g., the first image capturing device 110A) may be configured to communicate the captured image frames as input to the respective node (i.e., the first node 108A) from the first plurality of nodes 108 or the second plurality of nodes 112 for further processing (for example generation of statistical information). Each image capturing device (e.g., the first image capturing device 110A) may be implemented by use of a charge-coupled device (CCD) technology or complementary metal-oxide-semiconductor (CMOS) technology. Examples of the image capturing device (such as, the first image capturing device 110A) may include, but are not limited to, an image sensor, a wide-angle camera, an action camera, a closed-circuit television (CCTV) camera, a camcorder, a digital camera, camera phones, a time-of-flight camera (ToF camera), a night-vision camera, a 360-degree camera, and/or other image capture devices. In accordance with an embodiment, the image capturing device (e.g., the first image capturing device 110A) may be implemented as an integrated unit of the respective node (i.e., the first node 108A) or as a separate device.

The second computing device 116 may include suitable logic, circuitry, interfaces, and/or code that may be associated with a user, such as the audience member 124 to whom the advertisement content may be rendered through the selected node (such as the first node 108A). The second computing device 116 may be owned by the audience member 124. The second computing device 116 may be configured to interact with metadata information associated with the rendered advertisement content and/or may receive supplemental content from the first node 108A based on the interaction with the metadata information. Examples of the second computing device 116 may include, but are not limited to, a mobile phone, a smart phone, a personal digital assistant (PDA), a tablet computing device, a computer workstation, a gaming console, a head-mounted device, an automotive electronic device, or other consumer electronic device.

The communication network 122 may include a medium through which the server 102 may connect with the electronic apparatus 104, the first computing device 106, the first plurality of nodes 108, the second plurality of nodes 112, or the second computing device 116 directly or indirectly. Examples of the communication network 122 may include, but are not limited to, the Internet, a cloud network, a Long Term Evolution (LTE) network, a Wireless Local Area Network (WLAN), a Local Area Network (LAN), a telephone line (POTS), or other wired or wireless network. Various devices in the network environment 100 may be configured to connect to the communication network 122, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

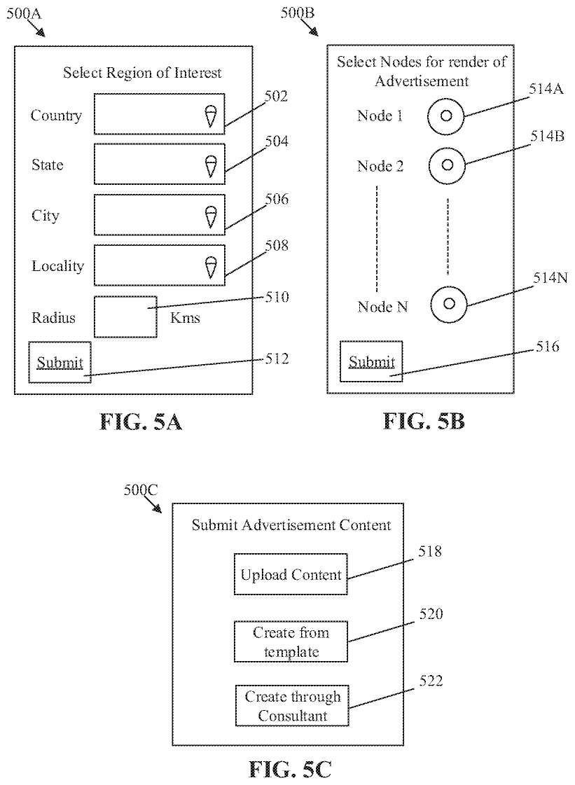

In operation, the server 102 (for example an advertisement server or advertisement platform) may be configured to receive the first information from the electronic apparatus 104 which may be associated with the advertiser 128. The first information may indicate the geographical region of interest to render the advertisement content on one or more of the plurality of nodes located in the geographical region of interest. Example of the geographical region of interest may include, but is not limited to, a city, a town, a state, a country, a locality, or a geo-graphical region. In accordance with an embodiment, the server 102 may be configured to control the electronic apparatus 104 to present a user interface (UI) to the advertiser 128 to select a region of interest from a plurality of regions (such as, the first region 118A and the second region 118B). In case, the advertiser 128 selects the first region 118A, the first information may include an indication or identification of the selected first region 118A to render the advertisement content on one or more of the first plurality of nodes 108 in the first region 118A. The server 102 may be further configured to receive the second information from the electronic apparatus 104. The second information may indicate the user selection of one or more nodes from the plurality of nodes located in the selected region of interest, to render the advertisement content. In an example, the server may control the electronic apparatus 104 to present another UI to the advertiser 128 to select the one or more nodes from the plurality of nodes (i.e., the first plurality of nodes 108) located in the selected region of interest (i.e., the first region 118A). The selection of the geographical region of interest and the one or more nodes (e.g. from the first plurality of nodes 108) located in the selected region-of-interest is described, for example, in FIGS. 3, 5A, and 5B. In accordance with an embodiment, the server 102 may be further configured to transmit the advertisement content to the selected node (or selected multiple nodes) from the plurality of nodes located in the region of interest. For example, the server 102 may transmit the advertisement content to the first node 108A in case the first node 108A is the selected node in the region-of-interest. In another example, in case the first node 108A and the second node 108B are selected from the first plurality of nodes 108, the server 102 may transmit the advertisement content to the selected nodes, i.e., the first node 108A and the second node 108B.

In accordance with an embodiment, the electronic apparatus 104 may be configured to receive the first user-input from the advertiser 128. The first user-input may be associated with selection of the geographical region of interest from the plurality of regions to render the advertisement content on one or more nodes from the plurality of nodes located in the selected region of interest. Based on the received first user-input, the electronic apparatus 104 may be configured to generate the first information. The electronic apparatus 104 may be configured to transmit the first information to the server 102. The electronic apparatus 104 may be further configured to receive the second user-input from the advertiser 128. The second user-input may include a user-selection of a node from the plurality of nodes located in the previously selected region of interest. For example, the first node 108A may be selected as the user-selected node from the first plurality of nodes 108 within the first region 118A, in case the first region 118A is selected as the region of interest (based on the first user-input). The electronic apparatus 104 may be configured to generate the second information based on the second user-input. Thereafter, the electronic apparatus 104 may transmit the second information to the server 102 to render the advertisement content on the selected node (e.g., the first node 108A).

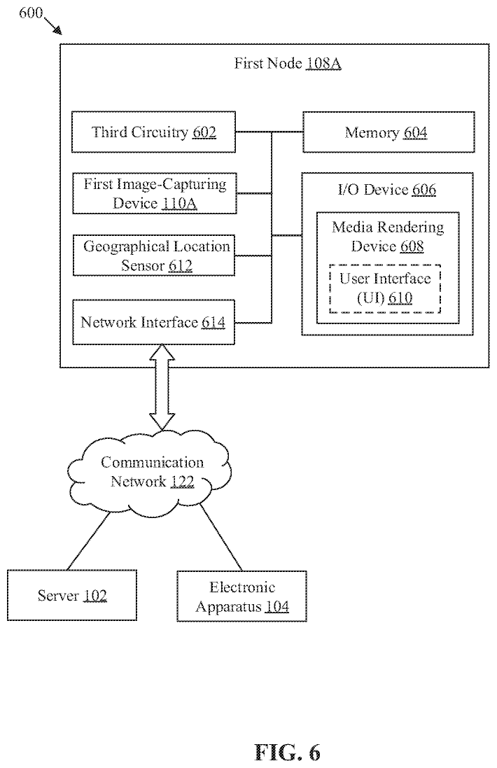

In accordance with an embodiment, the selected node (e.g., the first node 108A) may be configured to receive the advertisement content from the server 102 and render the received advertisement content for the audience member 124. During the rendering of the advertisement content, the selected node may control an image capturing device (e.g., the first image capturing device 110A) corresponding to the selected node (i.e., the first node 108A) to capture one or more images of the audience member 124. The selected node (e.g., the first node 108A) may be further configured to generate third information associated with advertisement content based on the captured one or more images. Thereafter, the selected node (e.g., the first node 108A) may transmit the generated third information to the server 102 for generation of statistical information based on the third information. The details for the third information and the generation of the statistical information is described, for example, in FIG. 6.

In accordance with an embodiment, the second computing device 116 of the audience member 124 may monitor an interaction of the second computing device 116 with the metadata information included in the advertisement content. Based on the interaction, the second computing device 116 may transmit a request for the supplemental content to the server 102. In response to the transmitted request, the second computing device 116 may be configured to receive the supplemental content from the server 102 and render the supplemental content on the second computing device 116 for the audience member 124. The control of the advertisement based on the location selection is described, for example, in FIGS. 3, 7 and 8.

According to embodiments of the present disclosure, the server 102 may enable the advertiser 128 (or the associated electronic apparatus 104) to pin-point and select individual nodes located in the region of interest selected by the advertiser 128 to render the advertisement content. This may enable delivery of the advertisement content to a selected target node based on selection criteria chosen by the advertiser 128. For example, advertisements of a food brand may be relevant for nodes (such as, kiosks) in a departmental or grocery stores in the selection region of interest. The electronic apparatus 104 may allow the advertiser 128 to select different nodes located in the region of interest (for example a city) or in the departmental or grocery stores to render advertisement content related to the food items. Such targeted advertisement may attract attention from the audience (i.e. who may be present in a vicinity of the selected node) due to a high relevancy of the advertisement content for the node. Targeted advertisement at such selected nodes may enhance brand awareness of advertised products/services and may further increase sales of the advertised products/services for the advertiser 128.

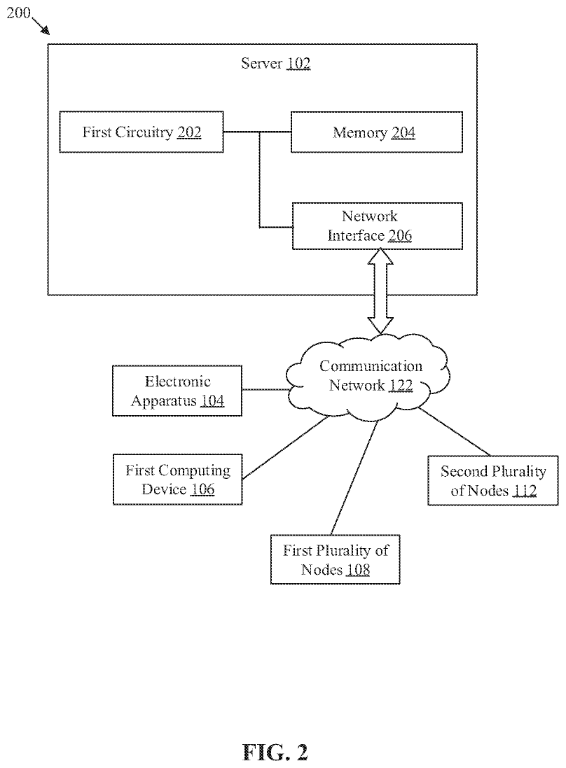

FIG. 2 is a block diagram that illustrates an exemplary server for advertisement control based on location selection, in accordance with an embodiment of the disclosure. FIG. 2 is explained in conjunction with elements from FIG. 1. With reference to FIG. 2, there is shown a block diagram 200 that depicts a server, such as the server 102. The server 102 may include first circuitry 202, a memory 204, and a network interface 206. The network interface 206 may communicatively couple the server 102 with the electronic apparatus 104, the first computing device 106, the first plurality of nodes 108, and the second plurality of nodes 112, via the communication network 122. The server 102 may be additionally communicatively coupled to the second computing device 116, via the communication network 122 (though not shown in FIG. 2).

The first circuitry 202 may include suitable logic, circuitry, interfaces, and/or code that may be configured to execute program instructions associated with different operations to be executed by the server 102. For example, some of the operations may include reception of the first information and second information from the electronic apparatus 104 and transmission of the advertisement content to a selected node (e.g., the first node 108A). The selected node may be indicated in the second information. The first circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The first circuitry 202 may be implemented based on a number of processor technologies known in the art. Examples of implementations of the first circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may comprise suitable logic, circuitry, and/or interfaces that may be configured to store a set of instructions executable by the first circuitry 202. The memory 204 may be configured to store the geographical location information associated with each of the plurality of nodes in a region. Further, the memory 204 may store the statistical information and cost information associated with the advertisement content. The memory 204 may be further configured to store user profile information and preference information associated with the advertiser 128. The memory 204 may be further configured to store the advertisement content to be provided to the selected node. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may comprise suitable logic, circuitry, interfaces, and/or code that may be configured to enable communication between the server 102, the electronic apparatus 104, the first computing device 106, the first plurality of nodes 108, and the second plurality of nodes 112, via the communication network 122. In an embodiment, the network interface 206 may also communicatively couple the server 102 with the second computing device 116, via the communication network 122 (though not shown in FIG. 2). The network interface 206 may implement known technologies to support wired or wireless communication with the communication network 122. The network interface 206 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Long Term Evolution (LTE), Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.120g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS). The control of the advertisement based on location selection is described further, for example, in FIGS. 3, 5A-5C, 7, and 8.

FIG. 3 is a sequence diagram that illustrates a first implementation scenario of advertisement control based on location selection, in accordance with an embodiment of the disclosure. FIG. 3 is explained in conjunction with elements from FIG. 1 and FIG. 2. With reference to FIG. 3, there is shown a sequence diagram 300 that illustrates a sequence of operations for advertisement control based on location selection. The sequence of operations may be executed by various elements of the network environment 100, such as, but not limited to, the server 102, the electronic apparatus 104, the first plurality of nodes 108, and the second plurality of nodes 112.

At 302A, geographical location of each node of the first plurality of nodes 108 may be determined. In an embodiment, each node of the first plurality of nodes 108 may be configured to determine the geographical location based on an integrated geographical location sensor (such as geographical location sensor 612 in FIG. 6) and generate geographical location information associated with the node. For example, the first node 108A in the first region 118A may use an integrated geographical location sensor 612 to determine a geographical location (such as the first geographical location 120A) of the first node 108A. The first node 108A may generate the geographical location information that may include the geographical location (for example latitude information, longitude information OR GPS coordinates) associated with the first node 108A. In some embodiments, the geographical location information of the first node 108A may additionally or alternatively include an indication of a country, a state/province, a city/town, and a locality/area, associated with the first node 108A or in which the first node 108A may be situated. In some embodiments, the geographical location information of the first node 108A or others of the first plurality of nodes 108 may be pre-stored in the memory 204 of the server 102.

At 302B, geographical location of each node of the second plurality of nodes 112 may be determined. In an embodiment, each node in the second plurality of nodes 112 may be configured to determine the geographical location of the node and generate the geographical location information associated with the corresponding node. For example, the first node 112A in the second region 1188 (i.e. different from the first region 118A) may determine a geographical location (such as the second geographical location 1208) of the first node 112A, using the integrated geographical location sensor 612. In some embodiments, the geographical location information of the first node 112A in the second region 1188 or others of the second plurality of nodes 112 may be pre-stored in the memory 204 of the server 102.

At 304A, each node of the first plurality of nodes 108 may transmit the determined geographical location information of the node to the server 102. In an embodiment, the first circuitry 202 of the server 102 may be configured to receive the geographical location information of each node from the respective node. Thereafter, the server 102 may store the received geographical location information of each node of the first plurality of nodes 108 in the memory 204 of the server 102. In some embodiments, the first circuitry 202 of the server 102 may receive the geographical location information whenever there is a change in the geographical location of one or more nodes of the first plurality of nodes 108.

At 304B, each node of the second plurality of nodes 112 may transmit the geographical location information of the node to the server 102. In an embodiment, the first circuitry 202 of the server 102 may be configured to receive the geographical location information of each node of the second plurality of nodes 112 from the corresponding node of the second plurality of nodes 112. Thereafter, the server 102 may store the receive geographical location information of each node of the second plurality of nodes 112 in the memory 204 of the server 102. In some embodiments, the first circuitry 202 may receive the geographical location information whenever there is a change in the geographical location of one or more nodes of the second plurality of nodes 112.

At 306, the electronic apparatus 104 may transmit the first information to the server 102. The first information may indicate a selected region of interest to render the advertisement content. The electronic apparatus 104 may receive a first user-input (i.e. from the advertiser 128) which may indicate the region of interest selected by the advertiser 128 to render the advertisement content, via one or more nodes of the first plurality of nodes 108 or the second plurality of nodes 112. For example, the advertiser 128 may select the first region 118A (such as a particular locality, city, state, town, or country) to the render the advertisement content, where the selected first region 118A may correspond to the selected region of interest. An example of a user-interface presented by the electronic apparatus 104 to the advertiser 128 to receive the first user-input is described, for example, in FIG. 5A. The first circuitry 202 of the server 102 may be configured to receive the first information from the electronic apparatus 104 based on the selected region-of-interest.

At 308, the geographical location information or identification information associated with each node of the plurality of nodes in the selected region of interest may be transmitted by the server 102 to the electronic apparatus 104. The server 102 may be configured to transmit, to the electronic apparatus 104, the geographical location information associated with each node of the plurality of nodes in the selected region of interest. For example, in case the selected region of interest is the first region 118A, the server 102 may transmit the geographical location information (for example the first geographical location 120A for the first node 108A) of each of the first plurality of nodes 108 located in the first region 118A. In some embodiments, the memory 204 of the server 102 may store geographical location information of the selected region of interest. The first circuitry 202 may be configured to compare the stored geographical location information of the selected region of interest and the received geographical location information of each of the first plurality of nodes 108 and/or the second plurality of nodes 112 to identify one or more nodes present or located with the selected region of interest. For example, in case of selection of the first region 118A, the first circuitry 202 may identify the first plurality of nodes 108 (i.e. the first node 108A, the second node 1088) within the selected first region 118A and further transmit the identification information of each of the first plurality of nodes 108 to the electronic apparatus 104. Examples of the identification information, may include, identification of a place (such as name of a shop or departmental store) where the particular node is situated, address information of the particular node, or geo-location of the particular node.

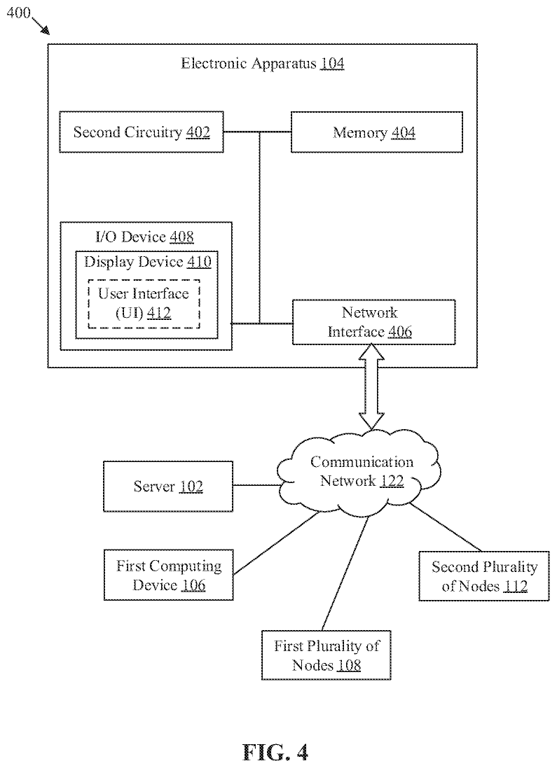

At 310, the received geographical location information or the identification information of each node in the selected region of interest may be displayed on the electronic apparatus 104. For example, in case the first region 118A is selected as the region of interest, the electronic apparatus 104 may display the received geographical location information or the identification information of each node of the first plurality of nodes 108 in the selected region of interest (such as the first region 118A). In such case, the displayed identification information and/or the geographical location information may indicate the first plurality of nodes 108 (and the respective geographical locations such as the first geographical location 120A) situated within the selected first region 118A as shown in FIG. 5B, as an example. In an embodiment, the electronic apparatus 104 may display the identification information and the geographical location information of the first plurality of nodes 108 in navigational map data. Alternatively, the electronic apparatus 104 may display a textual or image representation of the identification information and the geographical location information of each of the first plurality of nodes 108 present within the selected region of interest (such the first region 118A). In some embodiments, the identification information and the geographical location information for the first plurality of nodes 108 may be stored in a memory (such as memory 404 in FIG. 4) of the electronic apparatus 104. In such case, based on the selection of the region of interest (e.g. the first region 118A), the electronic apparatus 104 may be configured to retrieve the identification information and the geographical location information of the first plurality of nodes 108 from the memory 404, without a need to receive from the server 102. In some embodiments, the electronic apparatus 104 may be configured to request the server 102 to share a change in the identification information and/or the geographical location information of the first plurality of nodes 108 present in the selected first region 118A.

At 312, the second information about the user-selection of the node of the plurality of nodes (i.e. located in the selected region of interest) may be transmitted by the electronic apparatus 104 to the server 102. The second information may indicate a selection of the node in the plurality of nodes (i.e. located in the selected region of interest) to render the advertisement content. The electronic apparatus 104 may be configured to receive a second user-input from the advertiser 128. The second user-input may indicate the node selected by the advertiser 128 from the plurality of nodes to render the advertisement content. For example, the advertiser 128 may select the first node 108A from the first plurality of nodes 108 in the selected first region 118A to render the advertisement content, in case the selected region of interest corresponds to the first region 118A. An example of a user-interface presented by the electronic apparatus 104 to the advertiser 128 to receive the second user-input is described, for example, in FIG. 5B. The electronic apparatus 104 may be configured to generate the second information based on the receipt of the second user-input from the advertiser 128. The second information may indicate the identification information or the geographical location information of the selected node (such as the first node 108A) from the first plurality of nodes 108. In accordance with an embodiment, the first circuitry 202 of the server 102 may be configured to receive the generated second information from the electronic apparatus 104.

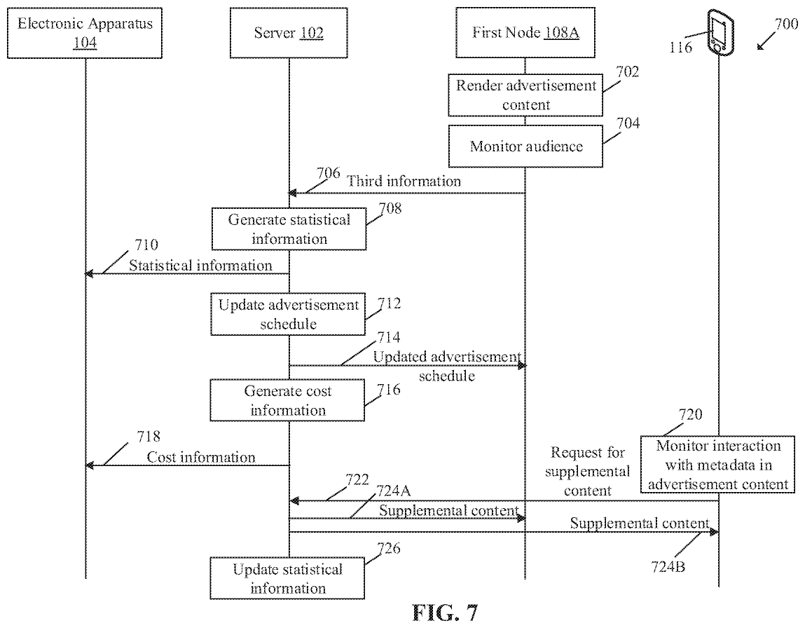

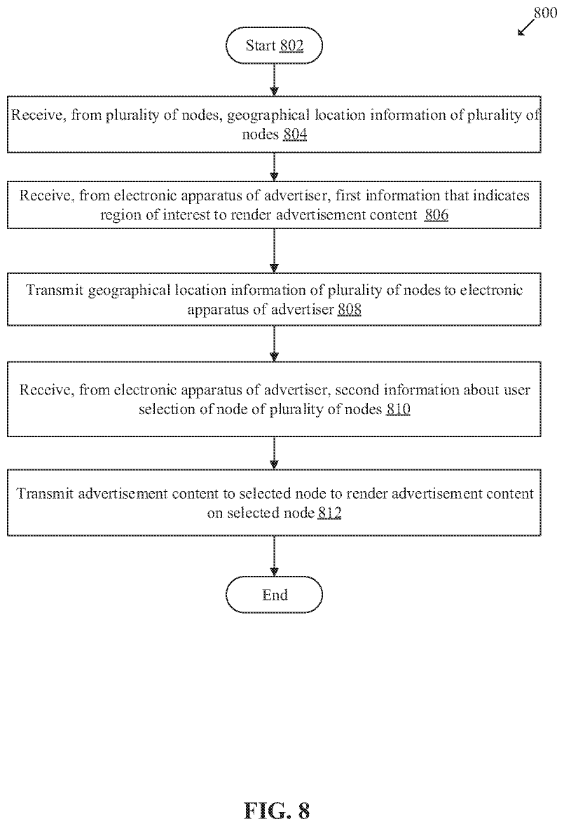

At 314, the first circuitry 202 of the server 102 may be further configured to transmit the advertisement content to the selected node of the plurality of nodes in the selected region of interest. For example, the first circuitry 202 may be configured to transmit the advertisement content to the first node 108A to render the advertisement content on the first node 108A, in case the first node 108A is the selected node. An example of a user-interface presented by the electronic apparatus 104 to the advertiser 128 for the generation of the advertisement content is described, for example, in FIG. 5C. In some embodiments, the first circuitry 202 may be configured to retrieve the predefined advertisement content (i.e. associated with the advertiser 128) from the memory 204. In other embodiments, the first circuitry 202 of the server 102 may be configured to receive the advertisement content from the electronic apparatus 104 along with the second information about the selection of the node. In case of selection of multiple nodes, the first circuitry 202 may be configured to retrieve different predefined advertisement content corresponding to each of the multiple selected nodes. In accordance with an embodiment, the selected node (e.g., the first node 108A) may be configured to render the received advertisement content. Examples of the advertisement content may include, but are not limited to, video content, image content, audio content, text content, multi-media content, animated content, or interactive content. The prestored advertisement content may be generated by one of the server 102, the electronic apparatus 104 associated with the advertiser 128, or the first computing device 106 associated with the advertisement consultant 130 (or the advertisement agent). Thus, the disclosed server 102 may receive the selection of the geographical region of interest and the nodes within the region of interest from the electronic apparatus 104, and further control rendering of the advertisement content on the selected nodes. The advertisement content may be associated with the selected nodes, the advertiser 128, or the geographical location of the selected nodes. The control of the advertisement content based on location selection is explained further, for example, in FIGS. 7 and 8.

Although the sequence diagram 300 is illustrated as discrete operations, such as 302A, 302B, 304A, 304B, 306, 308, 310, 312, and 314, the disclosure is not so limited. Accordingly, in certain embodiments, such discrete operations may be further divided into additional operations, combined into fewer operations, or eliminated, depending on the particular implementation without detracting from the essence of the disclosed embodiments.

FIG. 4 is a block diagram that illustrates an exemplary electronic apparatus for advertisement control based on location selection, in accordance with an embodiment of the disclosure. FIG. 4 is explained in conjunction with elements from FIGS. 1, 2 and 3. With reference to FIG. 4, there is shown a block diagram 400 that depicts an electronic apparatus, such as the electronic apparatus 104. The electronic apparatus 104 may include second circuitry 402, a memory 404, a network interface 406, an Input/Output (I/O) device 408, a display device 410, and a user interface (UI) 412. The network interface 406 may communicatively couple the electronic apparatus 104 with the server 102, the first computing device 106, the first plurality of nodes 108, and the second plurality of nodes 112, via the communication network 122.

The second circuitry 402 may include suitable logic, circuitry, interfaces, and/or code that may be configured to execute program instructions associated with different operations to be executed by the electronic apparatus 104. For example, some of the operations may include generation of the first information and the second information based on the first user-input and the second user-input, respectively, received from the advertiser 128. The second circuitry 402 may be further configured to transmit the first information and the second information to the server 102. In some embodiments, the second circuitry 402 may be configured to generate or retrieve the advertisement content based on the selected nodes indicated in the second information. The second circuitry 402 may include one or more specialized processing units, which may be implemented as a separate processor. In an embodiment, the one or more specialized processing units may be implemented as an integrated processor or a cluster of processors that perform the functions of the one or more specialized processing units, collectively. The second circuitry 402 may be implemented based on a number of processor technologies known in the art. Examples of implementations of the second circuitry 402 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 404 may comprise suitable logic, circuitry, and/or interfaces that may be operable to store a set of instructions executable by the second circuitry 402. The memory 404 may be configured to store the advertisement content corresponding to the first plurality of nodes 108 and/or the second plurality of nodes 112. In some embodiments, the memory 404 may store profile information and preference information associated with the advertiser 128. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card. The functions of the network interface 406 may be same as the functions of the network interface 206 described, for example, in FIG. 2. Therefore, the description of the network interface 406 is omitted from the disclosure for the sake of brevity.

The I/O device 408 may comprise suitable logic, circuitry, interfaces, and/or code that may be configured to receive an input and provide an output based on the received input. The I/O device 408 may include various input and output devices, which may be configured to communicate with the second circuitry 402. The I/O device 408 may be configured to receive the first-user input and the second-user input from the advertiser 128 to select the region of interest and one or more nodes from the plurality of nodes within the selected region-of-interest. Examples of the I/O device 408 may include, but are not limited to, a touch screen, a keyboard, a mouse, a joystick, a display device (for example, the display device 410), a microphone (not shown in FIG. 4), and a speaker (not shown in FIG. 4). The display device 410 may comprise suitable logic, circuitry, and interfaces that may be configured to display an output of the electronic apparatus 104. The display device 410 may be utilized to render the UI 412. In some embodiments, the display device 410 may be an external display device associated with the electronic apparatus 104. The display device 410 may be a touch screen which may enable a user to provide a user-input via the display device 410. The touch screen may be at least one of a resistive touch screen, a capacitive touch screen, or a thermal touch screen. The display device 410 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 410 may refer to a display screen of a head mounted device (HMD), a smart-glass device, a see-through display, a projection-based display, an electro-chromic display, or a transparent display. An example of a user-interface presented on the display device 410 to receive the first user-input is explained further, for example, in FIG. 5A. An example of a user-interface presented on the display device 410 to receive the second user-input is explained further, for example, in FIG. 5B. An example of a user-interface presented on the display device 410 for the generation or selection of the advertisement content is explained further, for example, in FIG. 5C.

FIGS. 5A-5C are diagrams that collectively illustrate exemplary user interfaces that may be presented on a display device of the electronic apparatus of FIG. 4, in accordance with an embodiment of the disclosure. FIGS. 5A-5C are explained in conjunction with elements from FIGS. 1, 2, 3, and 4. With reference to FIG. 5A, there is shown a user interface (UI) 500A that may be presented on the display device 410 of the electronic apparatus 104. The UI 500A may include a first plurality of UI elements 502-508, a second UI element 510, and a third UI element 512.

In an embodiment, each of the first plurality of UI elements 502-508 may be, but is not limited to, a textbox or a drop-down list. Further, for example, the second UI element 510 may be a textbox, and the third UI element 512 may be a button as shown in FIG. 5A. The UI 500A may receive the first user-input from a user (such as the advertiser 128) of the electronic apparatus 104. The advertiser 128 and the electronic apparatus 104 may be associated with an organization (i.e. related to a product or a service) who may want to render the advertisement content on the selected nodes (for example television screen, kiosks, or digital billboards) to increase sales of their products or services. The first user-input may indicate a geographical region of interest selected to render the advertisement content. For example, advertiser 128 may select the first region 118A among the first region 118A and the second region 1188, as the region of interest to render the advertisement content. The second circuitry 402 of the electronic apparatus 104 may control the first plurality of UI elements 502-508 to receive the first-user input from the advertiser 128 or the user associated with the electronic apparatus 104 and select the region of interest based on the received first user-input.

For example, the second circuitry 402 of the electronic apparatus 104 may control a UI element 502 of the first plurality of UI elements 502-508 to receive a user-input indicative of a country in which the region of interest is located. Further, a UI element 504 of the first plurality of UI elements 502-508 may receive a user-input indicative of a state or province associated with the region of interest or within the selected country. In accordance with an embodiment, the second circuitry 402 may control a UI element 506 and a UI element 508 of the first plurality of UI elements 502-508 to receive user-inputs indicative of a city and a locality, respectively, in which the region of interest is located. Thus, the geographical region of interest may be selected based on user-inputs indicative of at least one of, but is not limited to, the country, state, city, or locality associated with the region of interest. For example, in case the received user-inputs indicate the country as “United States”, the state as “California”, and the city as “Los Angeles”, then the region of interest may be selected as “Los Angeles”. In some embodiments, the memory 404 of the electronic apparatus 104 may store different geographical regions. The second circuitry 402 may control the first plurality of UI elements 502-508 to retrieve the corresponding stored geographical regions (for example country, state, city, or locality) based on the user-inputs received on each of the UI element 502, the UI element 504, the UI element 506, the UI element 508. For example, in case, the UI element 502 receive the country as “United States”, then the second circuitry 402 may retrieve all the relevant states from the memory 404 based on the input country as “United States”. In some embodiments, the advertiser 128 may directly enter the city or locality (or any unique landmark) through the UI element 506 or the UI element 508, without any need to enter the country or the state (via UI element 502 or the UI element 504) to select the region of interest.

In addition, the second circuitry 402 of the electronic apparatus 104 may control the second UI element 510 to receive a user-input indicative of a radius (in meters, kilometers, or miles) associated with the selected region of interest. The radius (for example 10 miles) may define a coverage of the selected region of interest. For example, in case, the selected region of interest defines a city (for example “Los Angeles”), then the radius may define the distance coverage which may include the cities and/or geographical areas which may be within the radius (say 10 miles) around the selected city (say “Los Angeles”). In some embodiments, the advertiser 128 may define the region of interest based on one of the UI element 502, the UI element 504, the UI element 506, or the UI element 508, without the second UI element 510 (for radius). In accordance with an embodiment, the second circuitry 402 may receive a user-input through the third UI element 512 (for example button) to confirm or submit the region of interest selected via the first plurality of UI elements 502-508 and the second UI element 510. The second circuitry 402 may be further configured to generate the first information that may include the first user-input as indicative of the selected region of interest and transmit the generated first information to the server 102.

It may be noted that the UI 500A shown in FIG. 5A is presented merely as an example of a user interface for reception of the first-input indicative of the selected region of interest. The present disclosure may be also applicable to other types of Uls such as a UI that may enable the user (e.g., the advertiser 128) to select the region of interest through a map of one or more geographical locations, without departure from the scope of the disclosure. A description of other types of Uls has been omitted from the disclosure for the sake of brevity.

With reference to FIG. 5B, there is shown a UI 500B that may be presented on the display device 410 of the electronic apparatus 104. The UI 500B may include a second plurality of UI elements 514A-514N, and a fourth UI element 516. In an embodiment, each of the second plurality of UI elements 514A-514N may include, but is not limited to, one of a checkbox or a radio-button. In an embodiment, the fourth UI element 516 may be, for example, a button. In some embodiments, the UI 500B may be rendered on the display device 410 to the advertiser 128 based on the submission (via the third UI element 512) of the selected region of interest. The UI 500B may receive the second user-input from the user (such as the advertiser 128) of the electronic apparatus 104 to select the plurality of nodes within the region of interest selected, via the UI 500A. For example, the advertiser 128 may select the first node 108A as the selected node to render the advertisement content. The first node 108A may be selected among the first plurality of nodes 108 that may be located in the first region 118A, which may be selected as the region of interest, based on the first user-input via the UI 500A.

In an embodiment, the UI 500B may display information related to each node within the selected region of interest with an option to select the node to render the advertisement content. For example, the UI 500B may display the information related to the first plurality of nodes 108 with corresponding UI elements (such as the second plurality of UI elements 514A-514N) for selection of the nodes to render the advertisement content. For example, for the first plurality of nodes 108 with the selected first region 118A, the UI 500B may display a name, description, (i.e. the identification information) and/or geographical location information of the first plurality of nodes 108 along with the second plurality of UI elements 514A-514N to select the nodes. In some embodiments, the second circuitry 402 may retrieve the identification information and the geographical location information of the plurality of nodes (such as the first plurality of nodes 108) from the memory 404 for the selected region of interest. In other embodiments, the second circuitry 402 may receive the identification information and the geographical location information of the plurality of nodes from the server 102. The identification information and the geographical location information may indicate the plurality of nodes (and their locations) which may be associated with the advertiser 128 and located with the selected region of interest. The second circuitry 402 may control the second plurality of UI elements 514A-514N to receive the second-user inputs to select one or more nodes from the first plurality of nodes 108 (say within the first region 118A) to render the advertisement content. The advertiser 128 or the user of the electronic apparatus 104 may click or select at least one of the second plurality of UI elements 514A-514N to select the one or more modes (such as the first node 108A and/or the second node 108B) to render the advertisement content. In accordance with an embodiment, the second circuitry 402 may receive the second user-input through the fourth UI element 516 (for example UI button) to confirm or submit the one or more nodes selected via the second plurality of UI elements 514A-514N. The second circuitry 402 may be further configured to generate the second information that may include the second user-input as indicative of the selected nodes within the selected region of interest and may further transmit the generated second information to the server 102.

In an embodiment, the user selection of the node (e.g., the first node 108A) from the region of interest (e.g., the first region 118A) may be based on one of, but not limited to, a location of the node within the region of interest, an operational state of the node, historical data related to the advertisement content, demographics of the region of interest, at least one user profile in the region of interest, a schedule associated with the advertisement content, an occurrence of an event in the region of interest, and a node type of each of the plurality of nodes. For example, the advertiser 128 may select the node in case the location of the node in the region of interest lies in a commercial zone (for example with a good footfall or preferred by people). Further, in case the node is in a functional/operational condition, and the node has historically rendered the advertisement content for a period of time, then the node may be selected by the advertiser 128 through the UI 500A and the UI 500B displayed on the display device 410. For example, the demographics of the region of interest and user profiles (i.e. age, gender, social quotient, likes/dislikes, income, or professional status) associated with one or more audience members in the region of interest may be a basis for the selection of the node. For example, in case the advertisement content includes the media content associated with and/or targeted towards a particular demographics or user profiles, then the node selection may be based on the demographics of the region of interest and/or user profiles of the one or more audience members in the region of interest. In certain scenarios, the advertisement content may include the media content associated with and/or targeted towards certain demographics of a region and/or certain types of user profiles. In such scenario, the UI 500A and/or the UI 500B may present to the advertiser 128, an option to select the demographics or the types of user profiles. Based on the selected demographics or the types of user profiles, the electronic apparatus 104 and/or the server 102 may auto-select at least one of the advertisement content, a region of interest, or one or more nodes in the region of interest for the targeted advertisement. Thus, a node which may be located at a region of desired demographics or associated with audience members with targeted user profiles, may be selected as the node to render the advertisement content.

In another example, the schedule of render of the advertisement content may be a basis of selection of the node. For example, a node that is functional during the scheduled playback of the advertisement content may be selected by the advertiser 128. Further, an occurrence of an event in the region of interest may be a criterion for selection of the node. For example, in case, an event related to the advertisement content (such as a promotion event associated with a product/service advertised in the advertisement content) is scheduled to occur at a location in the region of interest, then the nodes nearby or in the region of interest may be selected to render the targeted advertisement content. In addition, a type of a node may also influence the selection of the node. For example, the advertiser 128 may select a node in case the node is a kiosk device, to render the advertisement content. In another example, a type of the advertisement content may also influence the selection of nodes. For example, in case the advertisement content is a video type, then the advertiser 128 may select the nodes (such as display screen, televisions) which may have the capability to render the video content.

It may be noted that the UI 500B shown in FIG. 5B is presented merely as an example of a user interface for reception of the second-input indicative of the selected nodes in the selected region of interest. The present disclosure may be also applicable to other types of UIs such as a UI that may display geographical locations of the nodes on a map and may enable a user (e.g., the advertiser 128) to select the nodes through the displayed map, without departure from the scope of the disclosure. A description of other types of UIs has been omitted from the disclosure for the sake of brevity. Further, in FIG. 5B, the first node 108A and the second node 108B illustrated as the selected nodes for the render of the advertisement content, is presented merely as an example. The present disclosure may be also applicable to selection of any number of nodes which may be present with the selected region of interest and selected through the UI 500B to render the advertisement content.

With reference to FIG. 5C, there is shown a UI 500C that may be presented on the display device 410 of the electronic apparatus 104. The UI 500C may include a fifth UI element 518, a sixth UI element 520, and a seventh UI element 522. For example, the fifth UI element 518, the sixth UI element 520, and the seventh UI element 522 may be, but is not limited to, a UI button to select or generate the advertisement content to be rendered on the selected nodes. For example, the second circuitry 402 may control the fifth UI element 518 to upload the advertisement content present in the memory 404 of the electronic apparatus 104. The uploaded media content may be pre-generated and/or pre-stored on the electronic apparatus 104. In some embodiments, the advertisement content may be stored in the memory 204 of the server 102, and the second circuitry 402 may transmit information about the advertisement content (i.e. uploaded or selected via the fifth UI element 518) to the server 102.

In another example, the second circuitry 402 may control the sixth UI element 520 to receive user-input to generate the advertisement content based on one or more media content templates stored on the server 102 or in the memory 404 of the electronic apparatus 104. The electronic apparatus 104 may download or receive the media content templates from the server 102 and further generate the advertisement content based on the media content templates. The second circuitry 402 of the electronic apparatus 104 may allow the user (e.g., the advertiser 128) to select a media content template from the downloaded media content templates and modify the selected media content template to generate the advertisement content.

In another example, the second circuitry 402 may control the seventh UI element 522 to initiate reception of user inputs, to further generate the advertisement content. The generation of the advertisement content may be based on inputs received from an advertisement consultant, such as, the advertisement consultant 130 (or advertisement agent). In such case, the second circuitry 402 may receive preferences information (such as media content type, media content playback duration, a celebrity preference, a brand jingle, or an advertisement storyline) associated with the advertisement content and/or a description associated with the product/service to be advertised, from the advertiser 128 based on the initiation of the seventh UI element 522. The second circuitry 402 may transmit the preferences information and the description to the first computing device 106 of the advertisement consultant 130, via the server 102 (or directly). The first computing device 106 may receive inputs from the advertisement consultant 130 (or the advertisement agent) for the generation of the advertisement content based on the received preferences information and the description. The first computing device 106 may be configured to generate the advertisement content based on predefined media content templates stored on the server 102 or on the first computing device 106. In some embodiments, the second circuitry 402 may transmit a request to the first computing device 106 to generate the advertisement content (related to the product/service associated with the advertiser 128) based on the selection of the seventh UI element 522. The first computing device 106 of the advertisement consultant 130 may generate and transmit the advertisement content to the electronic apparatus 104 based on the received request. It may be noted that the UI 500C shown in FIG. 5C is presented merely as an example of a user interface to select or generate the advertisement content to be rendered on the selected nodes. The present disclosure may be also applicable to other types of UIs to select or generate the advertisement content to be rendered on the selected nodes, without departure from the scope of the disclosure.

In accordance with an embodiment, the first circuitry 202 of the server 102 may be configured to automatically generate the advertisement content and select the nodes from the plurality of nodes in the region of interest, to render the advertisement content on the selected nodes. The first circuitry 202 of the server 102 may be configured to receive identification information associated with an advertiser (e.g., the advertiser 128) from the electronic apparatus 104. For example, the server 102 may receive user credentials (or profile information) associated with the advertiser 128 from the electronic apparatus 104, based on a login of the advertiser 128 with the server 102 by use of the electronic apparatus 104. In some embodiments, the memory 204 of the server 102 may pre-store the profile information and preference information associated with the advertiser 128. The server 102 may be configured to identify the profile information and the preference information based on the identification information of the advertiser 128. The server 102 may be further configured to generate the advertisement content based on at least one of the profile information or the preference information, associated with the advertiser 128. For example, the profile information may indicate that the advertiser 128 is associated with a beverage manufacture company. Further, for example, the preference information may indicate that the advertiser 128 prefers a video advertisement of certain duration (such as 15 to 30 seconds), in a particular media advertisement template, with a certain brand jingle, with a media content description (e.g., an advertisement storyline), or with a celebrity of interest. Accordingly, the server 102 may generate the advertisement content based on at least one of the advertisement storyline, including the product or service indicated by the profile information, video content of the particular duration that may be picturized on the celebrity of interest and with the brand jingle indicated by the preference information associated with the advertiser 128. The server 102 may also use the predefined media content template to generate the advertisement content. In another example, the server 102 may transmit the profile information and the preference information of the advertiser 128 to the first computing device 106 of the advertisement consultant 130 for the generation of the advertisement content. The advertisement consultant 130 may use the first computing device 106 to similarly generate the advertisement content based on the profile information and the preference information.

In accordance with an embodiment, first circuitry 202 of the server 102 may be further configured to select the nodes from the plurality of nodes in the region of interest (which may be previously selected by the advertiser 128) based on at least one of the profile information or the preference information, associated with the advertiser 128. For example, for a beverage related advertisement, the server 102 may select one or more nodes associated with a beverage and drinks section of a departmental store in the region of interest. Further, in case the preference information indicates that the type of a node to render the advertisement content is to be a kiosk device, the server 102 may select only a kiosk device in the beverage and drinks section as the selected node.

FIG. 6 is a block diagram that illustrates an exemplary node in a plurality of nodes located at a region of interest, for render of advertisement content, in accordance with an embodiment of the disclosure. FIG. 6 is explained in conjunction with elements from FIGS. 1, 2, 3, 4, 5A, 5B, and 5C. With reference to FIG. 6, there is shown a block diagram 600 that depicts a node, such as the first node 108A from the first plurality of nodes 108 in a geographical region of interest (e.g. the first region 118A). The first node 108A may include third circuitry 602, a memory 604, the first image capturing device 110A, an I/O device 606 which may further include a media rendering device 608 and a user interface 610. As shown in FIG. 6, the first node 108A may further include a geographical location sensor 612 and a network interface 614. The network interface 614 may communicatively couple the first node 108A with the server 102 and/or the electronic apparatus 104, via the communication network 122.

The third circuitry 602 may include suitable logic, circuitry, interfaces, and/or code that may be configured to execute program instructions associated with different operations to be executed by the first node 108A. For example, some of the operations may include reception of the advertisement content from the server 102 in case the first node 108A is a selected as a node from the region of interest (e.g., the first region 118A) to render the advertisement content. The third circuitry 602 may be further configured to control the render of the selected or generated advertisement content for one or more audience members, such as the audience member 124 who may be present in proximity to the first node 108A. The third circuitry 602 may be further configured to transmit the geographical location information associated with the geo-location of the first node 108A to the server 102. The third circuitry 602 may be further configured to determine third information associated with the advertisement content and transmit the third information to the server 102. The third circuitry 602 may include one or more specialized processing units, which may be implemented as a separate processor. In an embodiment, the one or more specialized processing units may be implemented as an integrated processor or a cluster of processors that perform the functions of the one or more specialized processing units, collectively. The third circuitry 602 may be implemented based on a number of processor technologies known in the art. Examples of implementations of the third circuitry 602 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 604 may comprise suitable logic, circuitry, interfaces, and/or code that may be operable to store a set of instructions executable by the third circuitry 602. The memory 604 may be configured to store the received advertisement content, the geographical location information and the third information associated with the rendered advertisement content or the audience member 124. Examples of implementation of the memory 604 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 606 may comprise suitable logic, circuitry, interfaces, and/or code that may be configured to receive an input and provide an output based on the received input. The I/O device 606 may include various input and output devices, which may be configured to communicate with the third circuitry 602. Examples of the I/O device 606 may include, but are not limited to, a touch screen, a keyboard, a mouse, a joystick, the media rendering device 608, or a microphone (not shown in FIG. 6). In accordance with an embodiment, the media rendering device 608 may include suitable logic, circuitry, interfaces, and/or code that may be configured to render media content. In an example, the media content may correspond to the advertisement content provided by the server 102 or the electronic apparatus 104. In an embodiment, the media rendering device 608 may be integrated with the first node 108A. In another embodiment, media rendering device 608 may be external to the first node 108A and may be communicatively coupled to the third circuitry 602 of the first node 108A to render the media content. Examples of the media rendering device 608 may include, but are not limited to, a television (TV), a display device, a sound system, a smart speaker, a kiosk screen or speaker. In some embodiments, the media rendering device 608 may include the user interface (UI) 610 to render the media content (such as the advertisement content) and/or receive user inputs from the audience member 124 who may interact with the corresponding node (such as the first node 108A). The audience member 124 may interact with the metadata information (such as QR code) included in the rendered advertisement content.

The geographical location sensor 612 may include suitable logic, circuitry, and/or interfaces that may be configured to determine a current geo-location of the node (such as the first node 108A). The geographical location sensor 612 may be further configured to generate the geographical location information associated with the current geo-location of the first node 108A, and transmit the geographical location information to the third circuitry 602. Examples of the geographical location sensor 612, may include, but are not limited to, a Global Navigation Satellite System (GNSS)-based sensor of the first node 108A. Examples of the GNSS-based sensor may include, but are not limited to, global positioning sensor (GPS), Global Navigation Satellite System (GLONASS), or other regional navigation systems or sensors. The functions of the network interface 614 may be same as the functions of the network interface 206 and the network interface 406 described, for example, in FIGS. 2 and 4. Therefore, the description of the network interface 614 is omitted from the disclosure for the sake of brevity.

FIG. 7 is a sequence diagram that illustrates a second implementation scenario for generation of statistical information based on rendered advertisement control, in accordance with an embodiment of the disclosure. FIG. 7 is explained in conjunction with elements from FIGS. 1, 2, 3, 4, 5A, 5B, 5C, and 6. With reference to FIG. 7, there is shown a sequence diagram 700 that illustrates a sequence of operations for advertisement control based on location selection. The sequence of operations may be executed by various elements of the network environment 100, such as, but not limited to, the server 102, the electronic apparatus 104, the first plurality of nodes 108, and the second computing device 116.

At 702, the advertisement content may be rendered by the selected node (for example the first node 108A). In an embodiment, the third circuitry 602 of the first node 108A may be configured to render the advertisement content on the media rendering device 608 of the first node 108A, in case the first node 108A is the selected node in the region of interest based on the second information. In an embodiment, in case the first node 108A is the selected node, the third circuitry 602 of the first node 108A may be configured to switch a render mode of the media rendering device 608 of the first node 108A from a first render mode to a second render mode. The third circuitry 602 of the selected first node 108A may be configured to render media content in the first render mode and configured to render the received advertisement content in the second render mode. Thus, based on the switching of the render mode of the first node 108A to the second render mode, the third circuitry 602 may be configured to render the received advertisement content on the media rendering device 608 of the first node 108A in the second render mode. For example, a non-selected node may operate in the first render mode and may playback the prestored media content that may be selected for playback by a user of the corresponding node. In case, the same node gets selected to render the advertisement content based on the second information and receives the advertisement content from the server 102, the selected node may automatically switch the render mode from the first render mode to the second render mode and may further render the received advertisement content. In certain cases, the switching of the render mode from the first render mode to the second render mode may require a manual confirmation from a user or owner of the node. Further, the third circuitry 602 of the first node 108A may control the media rendering device 608 to switch back from the second render mode to the first render mode on completion of a playback duration of the advertisement content or based on an input received from the user or owner of the node to switch back to the render mode.

At 704, an audience associated with the selected first node 108A may be monitored by the first node 108A. In an embodiment, the third circuitry 602 may monitor the audience (such as the audience member 124 associated with the first node 108A) who may view or listen to the advertisement content rendered on the first node 108A. To monitor the audience member 124, the third circuitry 602 may control the first image capturing device 110A to capture one or more images of the audience member 124 during the render of the advertisement content on the media rendering device 608 of the first node 108A. Based on the captured one or more images of the audience member 124, the third circuitry 602 may determine the third information associated with the rendered advertisement content or with the audience member 124. In accordance with an embodiment, the third information may include, but is not limited to, a captured image of the audience member 124, a duration for which the advertisement content may be rendered at the selected first node 108A, a duration for which the rendered advertisement content is viewed and/or heard by the audience member 124, a time of a day at which the advertisement content may be rendered at the selected first node 108A, or sound information in surrounding of the selected first node 108A. The sound information may correspond to an audio characteristic of sound produced in an environment around the first node 108A during the playback of the advertisement content. The audio characteristic may include, but is not limited to, a loudness parameter, a pitch parameter, a tone parameter, a voice quality parameter, a phonetic parameter, a voice modulation parameter, a pronunciation parameter, a prosody parameter, a timbre parameter, or one or more psychoacoustic parameters. The third information may indicate whether the rendered advertisement content is liked by the audience member 124 or not.

At 706, the third information may be transmitted by the selected first node 108A to the server 102. In an embodiment, the third circuitry 602 of the first node 108A may be configured to transmit the third information to the server 102. The first circuitry 202 of the server 102 may be configured to receive the third information from the first node 108A, via the communication network 122.

At 708, the statistical information may be generated by the server 102. In an embodiment, the first circuitry 202 of the server 102 may be configured to generate the statistical information associated with the rendered advertisement content based on the third information received from the first node 108A. In an embodiment, the statistical information may include at least one parameter that may indicate response or reaction of at least one audience (such as the audience member 124) of the advertisement content rendered on the selected first node 108A. The at least one parameter may correspond to, but is not limited to, at least one of a facial expression of the audience member 124, an emotional state of the audience member 124, a gesture of the audience member 124, or a user input (like comments) provided to the selected first node 108A by the audience member 124.

In an example, the received third information may include the captured one or more images of the audience member 124. The first circuitry 202 may determine the facial expression of the audience member 124 from the captured images based on use of a facial detection technique known in the art. The facial expression may indicate one or more motions or positions of muscles of a face of the audience member 124, where the facial expressions may manifest an emotion. The muscles of the face may move the skin of the audience member 124, may create facial lines/folds, or may cause the movement of facial features, such as mouth, head, nose, eye, eyebrows of the audience member 124. The first circuitry 202 may be configured to determine the emotional state of the audience member 124 based on the determined facial expression of the audience member 124. The plurality of categories of emotional states may include, but are not limited to, a happy emotion, a sad emotion, an angry emotion, a calm emotion, a fear emotion, a neutral emotion, an excited emotion, a confused emotion, a stressed emotion, a disgusted emotion, a surprised emotion, an excitement emotion, or a scared emotion. In another example, the first circuitry 202 may use an object detection technique known in the art to detect regions associated with a face, a hand, a leg, an elbow, and/or other body parts of the audience member 124 from the captured one or more images of the audience member 124. Thereafter, the first circuitry 202 may track a movement of the detected face, hand, leg, elbow and/or other body parts of the audience member 124 from the captured one or more images to determine the gestures of the audience member 124 based on use of an image pattern detection technique known in the art. The determined gestures (for example handclap gesture, “OK” gesture, “thump-up” gesture, or dance gesture) of the audience member 124 may indicate whether the rendered advertisement content is liked or not by the audience member 124. Thus, the generated statistical information may indicate the response of the audience member 124 (either through facial expressions, emotional states, gestures of body parts or provided user inputs like comments) made during or based on the playback of the advertisement content on the first node 108A. In other words, the statistical information may indicate whether the rendered advertisement content was successfully perceived by the audience member 124 of the first node 108A.

At 710, the generated statistical information may be transmitted by the server 102 to the electronic apparatus 104. In an embodiment, the first circuitry 202 may be configured to transmit the generated statistical information to the electronic apparatus 104. In an embodiment, the electronic apparatus 104 may be configured to display the received statistical information to the advertiser 128 on the electronic apparatus 104. For example, the electronic apparatus 104 may display a dashboard or report related to a rendering of the advertisement content on the display device 410 based on the received statistical information. Based on the displayed dashboard/report, the advertiser 128 may gauge a success and reach of an advertisement campaign associated with the advertisement content. In some embodiments, the advertiser 128 may control the electronic apparatus 104 to modify the advertisement content, the advertisement schedule associated with the advertisement content, or the selection of nodes based on the statistical information received and/or displayed as the dashboard/report.

In an embodiment, the server 102 may be further configured to transmit the generated statistical information to a web portal that may be accessible by at least one of the advertiser 128, the advertisement consultant 130, or an owner of the first node 108A. In an embodiment, the web portal may correspond to a Uniform Resource Locator (URL) that may enable a computing device connected to the communication network 122 to access the statistical information. For example, the web portal may enable the advertiser 128 to access the statistical information through the electronic apparatus 104. Further, the web portal may enable the advertisement consultant 130 to access the statistical information through the first computing device 106. In addition, the web portal may enable the owner of the first node 108A to access the statistical information through the first node 108A.

At 712, an advertisement schedule of the advertisement content may be updated by the server 102. In an embodiment, the first circuitry 202 may be configured to update the advertisement schedule of the advertisement content based on the statistical information. Based on the statistical information or the third information, the first circuitry 202 may determine that the advertisement content may be viewed or heard with interest by at least one audience (such as the audience member 124) during a certain time of the day or day of the week, based on the facial expressions, emotions, gestures, or user input of the at least one audience. Accordingly, the first circuitry 202 may update (for example increase) the advertisement schedule of the advertisement content such that the advertisement content may be rendered on the first node 108A with a certain render frequency or duration during the certain time of the day or day of the week. For example, during an evening time (e.g., between 5:00 pm to 8:00 pm) of a weekend day (e.g., Sunday), audiences of a certain demographic (e.g., in the age group of 25-35 years) may be targeted to render the advertisement content. The statistical information may indicate that the audience belongs to the particular demographic expressed a happy emotion, an inquisitive emotion, or an excited gesture while the render of the advertisement content. Thus, based on the statistical information, the first circuitry 202 may update the advertisement schedule of the advertisement content by increase of the render frequency or duration associated with render of the advertisement content on the first node 108A.

At 714, the updated advertisement schedule may be transmitted by the server 102 to the first node 108A. In an embodiment, the first circuitry 202 may be configured to transmit the updated advertisement schedule to the first node 108A so that the first node 108A may accordingly render the advertisement content based on the updated advertisement schedule. In another embodiment, the first circuitry 202 may transmit the advertisement content to the first node 108A based on the updated advertisement schedule of the advertisement content, instead of transmission of the updated advertisement schedule to the first node 108A.

At 716, cost information associated with the rendered advertisement content may be generated by the server 102. In an embodiment, the first circuitry 202 may be configured to generate the cost information associated with the rendered advertisement content, based on the render of the advertisement content on the first node 108A. In certain embodiments, the first circuitry 202 may generate the cost information based on the generated statistical information and one or more predetermined rules. In an embodiment, the cost information may correspond to a revenue model associated with the distribution of a monetary or non-monetary payment/reward amongst various entities (such as, the advertiser 128, the advertisement consultant 130, a user/owner of the selected first node 108A, and an organization/advertisement platform that operates the server 102) associated with the render of the advertisement content. In an example, the advertiser 128 may buy credits from the advertisement platform for render of the advertisement content on the selected first node 108A. Further, the advertisement platform may distribute a first portion of the credits purchased by the advertiser 128 to the advertisement consultant 130 and a second portion of the credits purchased by the advertiser 128 to the user/owner of the selected first node 108A. The advertisement platform may retain a remaining third portion of the credits purchased by the advertiser 128, as a revenue for the advertisement platform (for example the server 102). A person having ordinary skill in the art may understand that the revenue model based on credits is an exemplary revenue model associated with the cost information, and the disclosure is not so limited. The present disclosure may also include other revenue model that may be based on another payment or reward mode and other ways of distribution of payment/rewards, without departure from the scope of the disclosure. An example of cost information for a revenue model for advertisement content of different types is presented in Table 1:

TABLE 1
Cost information for an exemplary revenue model per 1000 advertisement (ad) views

| | | | | Credits | |
|---|---|---|---|---|---|
| | Maximum | Credits | Credits | earned | Credits |
| | Duration | spent | earned by | by an ad | retained |
| Advertisement | (in | by an | owner of a | agent or | by the ad |
| Type | seconds) | advertiser | host node | consultant | platform |
| Banner ad | 15 | 150 | 7.5 | 1.5 | 141 |
| Screen (Still) ad | 30 | 300 | 15 | 3 | 282 |
| Commercial ad | 30 | 300 | 15 | 3 | 282 |
| Story ad | 120 | 1200 | 60 | 12 | 1128 |
| Trailer ad | 180 | 1800 | 120 | 24 | 2256 |

As shown in Table 1, in case the advertisement content is a banner ad with a maximum duration of 15 seconds, the advertiser 128 may require a purchase of 150 credits from the advertisement platform, per 1000 views of the advertisement content by the audience (e.g., the audience member 124) of the selected first node 108A. In such case, the user/owner of the first node 108A (i.e. a host node) may earn 7.5 credits from the advertisement platform, per 1000 views of the advertisement content by the audience (e.g., the audience member 124) of the first node 108A. Further, in case the advertisement content is created by the advertisement consultant 130, the advertisement consultant 130 may earn 1.5 credits from the advertisement platform, per 1000 views of the advertisement content on the first node 108A. The advertisement platform may retain 141 credits out of the 150 credits bought by the advertiser 128, per 1000 views of the advertisement content on the first node 108A. Similarly, for other types of advertisement contents (such as still ads, commercial ads, story ads, and trailer ads), the Table 1 illustrates exemplary values of maximum advertisement duration (in seconds), credits spent by the advertiser 128, credits earned by the user/owner of the selected first node 108A, credits earned by the advertisement consultant 130, and credits retained by the advertisement platform.

In some embodiments, the advertiser 128, the advertisement consultant 130, and the user/owner of each node (including the selected first node 108A) may be pre-registered/subscribed to the advertisement platform (such as the server 102) based on a payment of a subscription cost (i.e., a purchase of a predetermined number of credits by each such entity) to the advertisement platform. In an example, the advertisement platform (such as the server 102) may require the user/owner of each node to purchase 2000 credits from the advertisement platform for subscription of the user/owner of the node with the advertisement platform for render of the advertisements on the node, so that the users/owners may later earn credits for render of the advertisements on the node. Further, as the advertisement consultant 130 may earn credits for the creation of the advertisements, the advertisement platform may require the advertisement consultant 130 to purchase 25 credits from the advertisement platform to subscribe with the advertisement platform. Since, the advertisement platform may require the advertiser 128 to purchase certain credits to post the advertisements for playback on the selected node, the advertisement platform may provide subscription to the advertiser 128 without any subscription cost. Thus, the advertisement platform (such as the server 102) may earn additional revenue from the payment of the subscription cost by the various entities.

At 718, the generated cost information may be transmitted to the electronic apparatus 104 by the server 102. In an embodiment, the first circuitry 202 may be configured to transmit the generated cost information to the electronic apparatus 104. In an example of the banner advertisement of the Table 1, the cost information transmitted to the electronic apparatus 104 may include information related to, but is not limited to, a number of views of the advertisement content and a number of credits consumed based on the number of views of the advertisement content. In an example, in case the number of credits consumed is less than a number of credits purchased by the advertiser 128 from the advertisement platform, the advertisement platform may refund the remaining credits to the advertiser 128. Further, in case the number of credits consumed exceeds a number of credits purchased by the advertiser 128, the advertisement platform may request the advertiser 128 to purchase the additional credits from the advertisement platform. The second circuitry 402 of the electronic apparatus 104 may display the received cost information to the advertiser 128 on the display device 410.

In an embodiment, the server 102 may be further configured to transmit the generated cost information to the web portal that may be accessible by at least one of the advertiser 128, the advertisement consultant 130, or the owner of the first node 108A. In an embodiment, the web portal may correspond to a Uniform Resource Locator (URL) that may enable a computing device connected to the communication network 122 to access the cost information. For example, the web portal may enable the advertiser 128 to access the cost information through the electronic apparatus 104. Further, the web portal may enable the advertisement consultant 130 to access the cost information through the first computing device 106. In addition, the web portal may enable the owner of the first node 108A to access the cost information through the first node 108A. In an example of the banner advertisement of the Table 1, the cost information may include information related to, but not limited to, a number of views of the advertisement content and a number of credits earned by the user/owner of the first node 108A for render of the advertisement content on the first node 108A. The third circuitry 602 of the first node 108A may display the cost information to the user/owner of the first node 108A on the media rendering device 608, based on an access to the web portal.

At 720, an interaction of the second computing device 116 with the metadata information in the advertisement content may be monitored by the second computing device 116 of the audience member 124. In an embodiment, the second computing device 116 of the audience member 124 may be configured to monitor the interaction of the second computing device 116 with the metadata information in the advertisement content. In some embodiments, the selected node (such as the first node 108A), on which the advertisement content is rendered), may monitor the interaction of the second computing device 116 with the metadata information. The advertisement content may include the metadata information such as, but not limited to, a barcode, a Quick-Response (QR) code, or a Uniform Resource Locator (URL) of a website, associated with the advertisement content. In an embodiment, the metadata information may be related to a product/service advertised in the advertisement content. For example, the audience member 124 may scan a barcode/QR code embedded in the advertisement content during or after the render of the advertisement content on the first node 108A, by use of the second computing device 116. The second computing device 116 may monitor such interaction (i.e., scan) with the metadata information (i.e., the barcode/QR code) in the advertisement content based on use of a predefined features (for example use of an integrated image capture device, near-field communication) of the second computing device 116.

At 722, a request for the supplemental content may be transmitted to the server 102 by the second computing device 116. In an embodiment, the second computing device 116 may be configured to transmit the request for the supplemental content associated with the advertisement content, based on the monitored and subsequent detection of the interaction with the metadata information in the advertisement content. The first circuitry 202 of the server 102 may be configured to receive the request for the supplemental content related to the advertisement content from the second computing device 116 based on the interaction between the metadata information and the second computing device 116 associated with the audience member 124.

At 724A, the supplemental content may be transmitted by the server 102 to the first node 108A. In an embodiment, the first circuitry 202 may be configured to transmit the supplemental content to the first node 108A based on the received request for the supplemental content. The third circuitry 602 of the first node 108A may be configured to receive the supplemental content and render the received supplemental content for the audience member 124.

At 724B, the supplemental content may be transmitted by the server 102 to the second computing device 116. In an embodiment, the first circuitry 202 may be configured to transmit the supplemental content to the second computing device 116 based on the received request for the supplemental content. The second computing device 116 may be configured to receive the supplemental content and render the received supplemental content for the audience member 124.

At 726, the statistical information may be updated by the server 102. In an embodiment, the first circuitry 202 may be configured to update the statistical information associated with the advertisement content, based on the transmitted supplemental content. The first circuitry 202 may be further configured to update the cost information based on the updated statistical information. For example, the first circuitry 202 may update the statistical information by update of the number of views of the advertisement content and the number of supplemental content requests for the advertisement content. Further, the first circuitry 202 may increase the number of credits earned by the user/owner of the first node 108A and may also increase the number of credits spent by the advertiser 128. In an embodiment, the first circuitry 202 may transmit the updated statistical information and the updated cost information to at least the electronic apparatus 104.

Although the sequence diagram 700 is illustrated as discrete operations, such as 702, 704, 706, 708, 710, 712, 714, 716, 718, 720, 722, 724A, 724B and 726, the disclosure is not so limited. Accordingly, in certain embodiments, such discrete operations may be further divided into additional operations, combined into fewer operations, or eliminated, depending on the particular implementation without detracting from the essence of the disclosed embodiments.

FIG. 8 depicts a flowchart that illustrates an exemplary method for advertisement control based on location selection, in accordance with an embodiment of the disclosure. With reference to FIG. 8, there is shown a flowchart 800. The flow chart is described in conjunction with FIGS. 1, 2, 3, 4, 5A, 5B, 5C, 6, and 7. The method starts at 802 and proceeds to 804. The exemplary method of the flowchart 800 may be executed by the server 102 or the first circuitry 202.

At 804, the geographical location information of a plurality of nodes may be received from the plurality of nodes. In an embodiment, the first circuitry 202 may be configured to receive the geographical location information of a plurality of nodes (e.g., the first plurality of nodes 108) from the plurality of nodes (i.e., the first plurality of nodes 108). Each of the first plurality of nodes 108 may determine the geographical location information of the corresponding node (e.g., the first node 108A) by use of a geographical location sensor (e.g., the geographical location sensor 612) of the node (i.e., the first node 108A). The first circuitry 202 may store the geographical location information of each of the first plurality of nodes 108 in the memory 204 of the server 102. The reception of the geographical location information of the plurality of nodes (e.g., the first plurality of nodes 108) is described, for example, in FIG. 3.

At 806, the first information, that may indicate the region of interest to render the advertisement content, may be received from the electronic apparatus 104 of the advertiser 128. In an embodiment, the first circuitry 202 of the server 102 may be configured to receive the first information from the electronic apparatus 104 of the advertiser 128. The first information may indicate the region of interest (e.g., the first region 118A) selected to render the advertisement content. The reception of the first information from the electronic apparatus 104 is described, for example, in FIGS. 3 and 5A.

At 808, the geographical location information of the plurality of nodes may be transmit to the electronic apparatus 104 of the advertiser 128. In an embodiment, the first circuitry 202 may be configured to transmit the geographical location information of the plurality of nodes (e.g., the first plurality of nodes 108) associated with the region of interest (i.e., the first region 118A) to the electronic apparatus 104. The electronic apparatus 104 may display the geographical location information on the display device 410 of the electronic apparatus 104. The transmission of the geographical location information to the electronic apparatus 104 for display at the electronic apparatus 104 is described, for example, in FIGS. 3 and 5B.

At 810, the second information about the user-selection of a node from the plurality of nodes may be received from the electronic apparatus 104 of the advertiser 128. In an embodiment, the first circuitry 202 may be configured to receive the second information that may indicate the user-selection of a node (e.g., the first node 108A) from the plurality of nodes (i.e., the first plurality of nodes 108) in the selected region of interest (i.e., the first region 118A). The reception of the second information is described, for example, in FIGS. 3 and 5B.

At 812, the advertisement content may be transmitted to the selected node to render the advertisement content on the selected node. In an embodiment, the first circuitry 202 may be configured to transmit the advertisement content to the selected node (e.g., the first node 108A) to render the advertisement content on the selected node (i.e., the first node 108A). The selection and the transmission of the advertisement content to the selected node (e.g., the first node 108A) is described, for example, in FIGS. 3 and 5C. The control may pass to end.

Although the flowchart 800 is illustrated as discrete operations, such as 804, 806, 808, 810, and 812, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer readable medium and/or storage medium, and/or a non-transitory machine readable medium and/or storage medium having stored thereon, a machine code and/or a set of instructions executable by a machine, such as a server, and/or a computer. The set of instructions in the server may cause the machine and/or computer to perform the operations that comprise reception of first information from an electronic apparatus. The first information may indicate a region of interest to render advertisement content. The region of interest may include a plurality of nodes to render the advertisement content. The operations may further comprise reception of second information from the electronic apparatus. The second information may be about a user selection of a node from the plurality of nodes located in the region of interest. The operations may further include transmission of the advertisement content to the selected node. The advertisement content may be rendered on the selected node.

Exemplary aspects of the disclosure may include a server (such as the server 102 in FIG. 1) that may include first circuitry (such as the first circuitry 202 in FIG. 2) that may be configured to receive first information from an electronic apparatus (such as the electronic apparatus 104 in FIG. 1). The first information may indicate a region of interest to render advertisement content. The region of interest (e.g. the first region 118A in FIG. 1) may include a plurality of nodes (i.e., the first plurality of nodes 108 in FIG. 1) to render the advertisement content. The first circuitry 202 of the server 102 may be further configured to receive second information from the electronic apparatus 104. The second information may be about a user selection of a node (e.g. the first node 108A in FIG. 1) from the plurality of nodes (i.e., the first plurality of nodes 108) located in the region of interest (i.e., the first region 118A). The first circuitry 202 may be further configured to transmit the advertisement content to the selected node (i.e. the first node 108A). The advertisement content may be rendered on the selected node (i.e. the first node 108A).

In an embodiment, the first circuitry 202 may be further configured to receive, from the plurality of nodes (e.g. the first plurality of nodes 108), geographical location information of the plurality of nodes (i.e. the first plurality of nodes 108). The first circuitry 202 may be configured to transmit the received geographical location information to the electronic apparatus 104. The geographical location information may be displayed at the electronic apparatus 104. The geographical location information may indicate geo-location of each node (e.g., the first node 108A, the second node 108B, . . . , the Nth node 108N) of the plurality of nodes (i.e. the first plurality of nodes 108) within the region of interest (i.e., the first region 118A). The first circuitry 202 may be further configured to receive, from the electronic apparatus 104, second information about the user selection of the node (e.g. the first node 108A) from the plurality of nodes (i.e. the first plurality of nodes 108) based on the displayed geographical location information.

The first circuitry 202 may be further configured to receive third information from the selected node (i.e., the first node 108A). The third information may be associated with the advertisement content rendered on the selected node (i.e., the first node 108A). The first circuitry 202 may then generate statistical information, associated with the rendered advertisement content, based on the received third information. The statistical information may include at least one parameter that may indicate response of at least one audience (such as the audience member 124 in FIG. 1) of the advertisement content rendered on the selected node (i.e., the first node 108A). The first circuitry 202 may be configured to transmit the generated statistical information to at least the electronic apparatus 104. The third information may include, but is not limited to, at least one of an image of the at least one audience (e.g., the audience member 124), a duration for which the advertisement content may be rendered at the selected node (i.e., the first node 108A), a duration for which the rendered advertisement content is viewed and/or heard by at least one audience (e.g., the audience member 124), a time of a day at which the advertisement content may be rendered at the selected node (i.e., the first node 108A), or sound information in surrounding of the selected node (i.e., the first node 108A).

In an embodiment, the first circuitry 202 may be configured to update, based on the generated statistical information, a schedule associated with the advertisement content rendered at the selected node (e.g., the first node 108A). The first circuitry 202 may then transmit the advertisement content to the selected node (i.e., the first node 108A) based on the updated schedule. The first circuitry 202 may further determine cost information associated with the advertisement content based on the generated statistical information.

In an embodiment, the at least one parameter, which may indicate the response of the at least one audience (e.g., the audience member 124) of the advertisement content, corresponds to, but is not limited to, at least one of a facial expression of the at least one audience (e.g., the audience member 124), an emotional state of the at least one audience (e.g., the audience member 124), a gesture of the at least one audience (e.g., the audience member 124), or a user input provided to the selected node (e.g., the first node 108A) by the at least one audience (e.g., the audience member 124).

In some embodiments, the advertisement content may include metadata information. The first circuitry 202 may be configured to receive a request for supplemental content, related with the advertisement content, from a computing device of the at least one audience (e.g., the second computing device 116 of the audience member 124 in FIG. 1) based on an interaction between the metadata information and the computing device (i.e., the second computing device 116). The first circuitry 202 may transmit the supplemental content to at least one of the selected node (e.g., the first node 108A) or the computing device (i.e., the second computing device 116) based on the received request. The first circuitry 202 may be further configured to update the statistical information associated with the advertisement content based on the transmitted supplemental content.

In an embodiment, the user selection of the node (e.g., the first node 108A) may be based on, but is not limited to, at least one of a location of the node (i.e., the first node 108A) within the region of interest (i.e., the first region 118A), an operational state of the node (i.e., the first node 108A), historical data related to the advertisement content, demographics of the region of interest (i.e., the first region 118A), at least one user profile in the region of interest (i.e., the first region 118A), a schedule associated with the advertisement content, an occurrence of an event in the region of interest (i.e., the first region 118A), and a node type of each node of the plurality of nodes (i.e., the first plurality of nodes 108).

The first circuitry 202 may be further configured to receive identification information associated with an advertiser (such as the advertiser 128 in FIG. 1) from the electronic apparatus 104. The first circuitry 202 may then generate the advertisement content based on at least one of profile information or preference information, associated with the identification information of the advertiser 128. The first circuitry 202 may be configured to select the node (e.g., the first node 108A) from the plurality of nodes (i.e., the first plurality of nodes 108) based on at least one of the profile information or the preference information, associated with the advertiser 128.

In an embodiment, a system for advertisement control based on location selection is provided. The system may include the server 102, the electronic apparatus 104, and a plurality of nodes (e.g., the first plurality of nodes 108). The server 102 may comprise the first circuitry 202. The electronic apparatus 104 may be communicatively coupled to the server 102 and may comprise second circuitry (such as the second circuitry 402 in FIG. 4). The second circuitry 402 of the electronic apparatus 104 may be configured to transmit the first information and the second information about a user input to the server 102. The first information may indicate the region of interest (e.g., the first region 118A) to render advertisement content. The region of interest (i.e., the first region 118A) may include the plurality of nodes (i.e., the first plurality of nodes 108), and the user input may include the user selection of a node (e.g., the first node 108A) from the plurality of nodes (i.e., the first plurality of nodes 108) located in the region of interest (i.e., the first region 118A). In accordance with an embodiment, each node (e.g., the first node 108A) of the first plurality of nodes 108 may be communicatively coupled to the server 102 and may include a media rendering device (such as the media rendering device 608 in FIG. 6) and third circuitry (such as the third circuitry 602 in FIG. 6). The first circuitry 202 of the server 102 may be configured to receive the first information and the second information about the user input from the electronic apparatus 104 and transmit the advertisement content to the selected node (e.g., the first node 108A). The third circuitry 602 of the selected node (i.e., the first node 108A) of the plurality of nodes (i.e., the first plurality of nodes 108) may be configured to render the advertisement content on the media rendering device 608.

In an embodiment, the third circuitry 602 of the selected node (i.e., the first node 108A) may be further configured to switch a render mode of the selected node (i.e., the first node 108A) from a first mode to a second mode. The selected node (i.e., the first node 108A) may be configured to render media content in the first mode and render the received advertisement content in the second mode. The third circuitry 602 may be configured to render the advertisement content on the media rendering device 608 in the second mode.

The third circuitry 602 of each node of the plurality of nodes (i.e., the first plurality of nodes 108) may be further configured to transmit the geographical location information of each node (e.g., the first node 108A) of the plurality of nodes (i.e., the first plurality of nodes 108) to the server 102. The first circuitry 202 of the server 102 may be configured to transmit the received geographical location information to the electronic apparatus 104. The geographical location information may be displayed at the electronic apparatus 104. The geographical location information may indicate geo-location of each node (e.g., the first node 108A) of the plurality of nodes (i.e., the first plurality of nodes 108) within the region of interest (i.e., the first region 118A). The first circuitry 202 may receive, from the electronic apparatus 104, the second information about the user selection of the node (e.g., the first node 108A) from the plurality of nodes (i.e., the first plurality of nodes 108) based on the displayed geographical location information.

The selected node (e.g., the first node 108A) of the plurality of nodes (i.e., the first plurality of nodes 108) may further comprise an image capturing device (e.g., the first image capturing device 110A) that may be configured to capture an image of at least one audience (e.g., the audience member 124) to whom the advertisement content may be rendered through the media rendering device 608 of the selected node (i.e., the first node 108A).

In an embodiment, the third circuitry 602 of the selected node (e.g., the first node 108A) may be further configured to transmit the captured image and the third information to the server 102. The third information may be associated with the advertisement content rendered at the selected node (i.e., the first node 108A). The first circuitry 202 of the server 102 may be further configured to generate the statistical information associated with the rendered advertisement content based on the captured image and the third information received from the selected node (i.e., the first node 108A). The statistical information may include the at least one parameter that may indicate response of the at least one audience (e.g., the audience member 124) of the advertisement content. The first circuitry 202 may be configured to determine the cost information associated with the advertisement content based on the generated statistical information. The first circuitry 202 may be configured to transmit the generated statistical information and the cost information to at least the electronic apparatus 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

1. A server, comprising:
circuitry configured to:
receive, from an electronic apparatus, first information that indicates a geographical region of interest to render advertisement content, wherein the geographical region of interest includes a plurality of nodes to render the advertisement content;
receive, from the electronic apparatus, second information about a user selection of a node from the plurality of nodes located in the geographical region of interest; and
transmit the advertisement content to the selected node, wherein the advertisement content is rendered on the selected node.

2. The server according to claim 1, wherein the circuitry is further configured to:
receive, from the plurality of nodes, geographical location information of the plurality of nodes;
transmit the received geographical location information to the electronic apparatus, wherein the geographical location information is displayed at the electronic apparatus, and wherein the geographical location information indicates geo-location of each node of the plurality of nodes within the geographical region of interest; and
receive, from the electronic apparatus, the second information about the user selection of the node from the plurality of nodes based on the displayed geographical location information.

3. The server according to claim 1, wherein the circuitry is further configured to:
receive third information from the selected node, wherein the third information is associated with the advertisement content rendered on the selected node;
generate statistical information, associated with the rendered advertisement content, based on the received third information, wherein the statistical information includes at least one parameter that indicates response of at least one audience of the advertisement content rendered on the selected node; and
transmit the generated statistical information to the electronic apparatus.

4. The server according to claim 3, wherein the third information includes at least one of an image of the at least one audience, a duration for which the advertisement content is rendered at the selected node, a duration for which the rendered advertisement content is viewed and/or heard by the at least one audience, a time of a day at which the advertisement content is rendered at the selected node, or sound information in surrounding of the selected node.

5. The server according to claim 3, wherein the circuitry is further configured to:
update, based on the generated statistical information, a schedule associated with the advertisement content rendered at the selected node; and
transmit the advertisement content to the selected node based on the updated schedule.

6. The server according to claim 3, wherein the circuitry is further configured to determine cost information associated with the advertisement content based on the generated statistical information.

7. The server according to claim 3, wherein the at least one parameter, which indicates the response of the at least one audience of the advertisement content, corresponds to at least one of a facial expression of the at least one audience, an emotional state of the at least one audience, a gesture of the at least one audience, or a user input provided to the selected node by the at least one audience.

8. The server according to claim 3, wherein the advertisement content includes metadata information, wherein the circuitry is further configured to:
receive a request for supplemental content, related with the advertisement content, from a computing device of the at least one audience based on an interaction between the metadata information and the computing device;
transmit the supplemental content to at least one of the selected node or the computing device based on the received request; and
update the statistical information associated with the advertisement content based on the transmitted supplemental content.

9. The server according to claim 1, wherein the user selection of the node is based on at least one of a location of the node within the geographical region of interest, an operational state of the node, historical data related to the advertisement content, demographics of the region of interest, at least one user profile in the region of interest, a schedule associated with the advertisement content, an occurrence of an event in the region of interest, or a node type of each of the plurality of nodes.

10. The server according to claim 1, wherein the circuitry is further configured to:
receive identification information associated with an advertiser from the electronic apparatus;
generate the advertisement content based on at least one of profile information or preference information, associated with the identification information of the advertiser; and
select the node from the plurality of nodes based on at least one of the profile information or the preference information, associated with the advertiser.

11. A method, comprising:
in a server:
receiving, from an electronic apparatus, first information that indicates a geographical region of interest to render an advertisement content, wherein the geographical region of interest includes a plurality of nodes to render the advertisement content;
receiving, from the electronic apparatus, second information about a user selection of a node from the plurality of nodes located in the geographical region of interest; and
transmitting the advertisement content to the selected node, wherein the advertisement content is rendered on the selected node.

12. The method according to claim 11, further comprising:
receiving, from the plurality of nodes, geographical location information of the plurality of nodes;
transmitting the received geographical location information to the electronic apparatus, wherein the geographical location information is displayed at the electronic apparatus, and wherein the geographical location information indicates geo-location of each node of the plurality of nodes within the geographical region of interest; and
receiving, from the electronic apparatus, the second information about the user selection of the node from the plurality of nodes based on the displayed location geographical information.

13. The method according to claim 11, further comprising:
receiving third information from the selected node, wherein the third information is associated with the advertisement content at rendered the selected node;
generating statistical information, associated with the rendered of the advertisement content, based on the received third information, wherein the statistical information includes at least one parameter that indicates response of at least one audience of the advertisement content rendered on the selected node; and
transmitting the generated statistical information to the electronic apparatus.

14. The method according to claim 13, wherein the third information includes at least one of an image of the at least one audience, a duration for which the advertisement content is rendered at the selected node, a duration for which the rendered advertisement content is viewed and/or heard by the at least one audience, a time of a day of at which the advertisement content is rendered at the selected node, or sound information in surrounding of the selected node.

15. The method according to claim 11, wherein the user selection of the node is based on at least one of a location of the node within the region of interest, an operational state of the node, historical data related to the advertisement content, demographics of the region of interest, at least one user profile in the region of interest, a schedule associated with the advertisement content, an occurrence of an event in the region of interest, or a node type of each of the plurality of nodes.

16. A non-transitory computer-readable medium having stored thereon, computer-executable instructions which, when executed by a computer, cause the computer to execute operations, the operations comprising:
receiving, from an electronic apparatus, first information that indicates a geographical region of interest to render advertisement content, wherein the geographical region of interest includes a plurality of nodes to render the advertisement content;
receiving, from the electronic apparatus, second information about a user selection of a node from the plurality of nodes located in the geographical region of interest; and
transmitting the advertisement content to the selected node, wherein the advertisement content is rendered on the selected node.

17. A system, comprising:
a server which comprises first circuitry;
an electronic apparatus communicably coupled to the server,
wherein the electronic apparatus comprises second circuitry configured to transmit first information and second information about a user input to the server, and
wherein the first information indicates a geographical region of interest to render advertisement content, the region of interest includes a plurality of nodes, and the user input includes a user selection of a node from the plurality of nodes located in the geographical region of interest; and
the plurality of nodes, wherein each node of the plurality of nodes comprises:
a media rendering device, and
third circuitry, wherein each node of the plurality of nodes is communicably coupled to the server,
wherein the first circuitry of the server is configured to:
receive the first information and the second information about the user input from the electronic apparatus, and
transmit the advertisement content to the selected node, and
wherein the third circuitry of the selected node of the plurality of nodes is configured to render the advertisement content on the media rendering device.

18. The system according to claim 17, wherein the third circuitry of the selected node is further configured to:
switch a render mode of the selected node from a first mode to a second mode, wherein the selected node is configured to render media content in the first mode and render the received advertisement content in the second mode; and
render the advertisement content on the media rendering device in the second mode.

19. The system according to claim 17, wherein
the third circuitry of each node of the plurality of nodes is further configured to transmit geographical location information of each node of the plurality of nodes to the server, and
the first circuitry of the server is further configured to:
transmit the received geographical location information to the electronic apparatus, wherein the geographical location information is displayed at the electronic apparatus, and wherein the geographical location information indicates geo-location of each node of the plurality of nodes within the geographical region of interest; and
receive, from the electronic apparatus, the second information about the user selection of the node from the plurality of nodes based on the displayed geographical location information.

20. The system according to claim 17, wherein
the selected node of the plurality of nodes further comprises an image capturing device configured to capture an image of at least one audience to whom the advertisement content is rendered through the media rendering device of the selected node,
the third circuitry of the selected node is further configured to transmit the captured image and third information to the server, and
the third information is associated with the advertisement content rendered at the selected node.

21. The system according to claim 20, wherein the first circuitry of the server is further configured to:
generate statistical information associated with the rendered advertisement content based on the captured image and the third information received from the selected node, wherein the statistical information includes at least one parameter that indicates response of the at least one audience of the advertisement content;
determine cost information associated with the advertisement content based on the generated statistical information; and
transmit the generated statistical information and the cost information to the electronic apparatus.

22. The system according to claim 20, wherein the third information includes at least one of the captured image of the at least one audience member, a duration for which the advertisement content is rendered at the selected node, a duration for which the advertisement content is viewed and/or heard by the at least one audience member, a time of a day at which the advertisement content is rendered at the selected node, or sound information in a surrounding of the selected node.
